(19) United States
(12) Patent Application Publication
(10) Pub. No.: US 2021/0160384 A1
(43) Pub. Date: May 27, 2021

(54) IMAGE FORMING APPARATUS CAPABLE OF WIRELESS COMMUNICATION WITH PORTABLE TERMINAL

(71) Applicant: Canon Kabushiki Kaisha, Tokyo (JP)

(72) Inventor: Daisuke Suga, Ibaraki (JP)

(21) Appl. No.: 16/953,812

(22) Filed: Nov. 20, 2020

(30) Foreign Application Priority Data
Nov. 22, 2019 (JP) 2019211776

(51) Int. Cl. H04N 1/00

(52) U.S. Cl. CPC H04N 1/00342; H04N 2201/006; H04N 1/00214; H04N 1/00307

(57) ABSTRACT

An image forming apparatus includes an image forming portion capable of forming an image on a sheet on the basis of image data image data sent from a portable terminal; a display panel for displaying a reading image including information for permitting wireless communication with the apparatus and readable by a camera of the portable terminal; and a controller capable of executing an operation in a first mode in which the display panel is turned on in a state that a main switch of the image forming apparatus is turned on and an operation in a second mode in which electric power consumption is smaller than electric power consumption in the first mode and in which the display panel is turned off. The controller causes the display panel to display the reading image in response to restoration from the second mode to the first mode.

### FIELD OF THE INVENTION AND RELATED ART

The present invention relates to an image forming apparatus such as a copying machine, a printer, a facsimile machine and a multi-function machine having a plurality of functions of these machines.

In recent years, as near field wireless communication, near field communication (hereinafter referred to as NFC) has been widely used. Further, an image forming apparatus which carries out communication with a portable terminal through this NFC and which permits wireless LAN communication has been proposed (for example, Japanese Laid-Open Patent Application (JP-A) 2018-29222). Further, in JP-A 2018-29222, it is proposed that in the case where failure of the NFC occurs, the wireless LAN communication is permitted by displaying a two-dimensional bar code and then by causing a portable terminal to read this two-dimensional bar code.

As described above, for permitting an operator to carry out the wireless LAN communication (wireless communication) with the image forming apparatus, the case where the two-dimensional bar code (reading image) is read by the portable terminal exists. However, in the image forming apparatus in recent years, in order to display the two-dimensional bar code, it is required that an operating portion is operated plural times in many cases, so that an operation for displaying the two-dimensional bar code becomes complicated.

### SUMMARY OF THE INVENTION

According to an aspect of the present invention, there is provided an image forming apparatus comprising: an image forming portion capable of forming an image on a sheet on the basis of image data sent from a portable terminal and received through wireless communication; a display panel configured to display a reading image which includes information for permitting wireless communication with the image forming apparatus and which is readable by a camera of the portable terminal; and a controller capable of executing an operation in a first mode in which the display panel is turned on in a state that a main switch of the image forming apparatus is turned on and an operation in a second mode in which electric power consumption is smaller than electric power consumption in the first mode and in which the display panel is turned off, wherein the controller causes the display panel to display the reading image in response to restoration from the second mode to the first mode.

According to another aspect of the present invention, there is provided an image forming apparatus comprising: an image forming portion capable of forming an image on a sheet on the basis of image data sent from a portable terminal and received through wireless communication; an operating panel including a display panel configured to display a reading image which includes information for permitting wireless communication with the image forming apparatus and which is readable by a camera of the portable terminal, and including an operating portion through which an operator is capable of inputting information by a touch operation; a controller capable of executing an operation in a first mode in which the display panel is turned on in a state that a main switch of the image forming apparatus is turned on and an operation in a second mode in which electric power consumption is smaller than electric power consumption in the first mode and in which the display panel is turned off, wherein the controller causes the display panel to display the reading image by a single operation performed by the operator on an initial screen of the display portion when an operation mode of the image forming apparatus is restored from the second mode to the first mode.

Further features of the present invention will become apparent from the following description of exemplary embodiments with reference to the attached drawings.

### BRIEF DESCRIPTION OF THE DRAWINGS

FIG. 1 is a front view of an image forming apparatus according to a first embodiment.

FIG. 2 is a perspective view of the image forming apparatus of the first embodiment.

FIG. 3 is a schematic sectional view of the image forming apparatus of the first embodiment.

FIG. 4 is a block diagram showing a constitution of a principal part of the image forming apparatus of the first embodiment.

FIG. 5 is a control black diagram of the image forming apparatus of the first embodiment.

FIG. 6 is a block diagram showing a constitution of power control of the image forming apparatus of the first embodiment.

FIG. 7 is a block diagram showing a part of a hardware constitution of the image forming apparatus of the first embodiment.

FIG. 8 is a block diagram showing a control constitution of NFC of the image forming apparatus of the first embodiment.

FIG. 9 is a schematic exploded perspective view of a structure of an operating panel in the first embodiment.

FIG. 10 is a block diagram showing a hardware constitution of a portable terminal in the first embodiment.

FIG. 11 is a block diagram showing a control constitution of NFC of the portable terminal in the first embodiment.

FIG. 12 is a schematic view for illustrating an outline of the NFC of the portable terminal with the image forming apparatus of the first embodiment.

FIG. 13 is a block diagram showing a constitution of a human sensor in the first embodiment.

FIG. 14 is a schematic view showing a detection region of the human sensor in the first embodiment.

FIG. 15 is a flowchart of control relating to wireless LAN connection in the first embodiment.

FIG. 16 is a schematic view showing a position screen of a two-dimensional bar code in the first embodiment.

FIG. 17 is a flowchart of control relating to the wireless LAN connection by the NFC in the embodiment 1.

Part (a) of FIG. 18 is a schematic view showing a screen of the portable terminal in the case where the wireless LAN connection is carried out by the NFC, and part (b) of FIG. 18 is a schematic view showing a screen of the portable terminal in the case where the wireless LAN connection is carried out by the two-dimensional bar code.

FIG. 19 is a flowchart of control relating to the wireless LAN connection by the two-dimensional bar code in the first embodiment.

FIG. 20 is a flowchart of control relating to the wireless LAN connection in a second embodiment.

FIG. 21 is a schematic view showing a display screen of an NFC target mark and a two-dimensional bar code in the second embodiment.

FIG. 22 is a flowchart of control relating to the wireless LAN connection in a third embodiment.

Part (a) of FIG. 23 is a schematic view showing a screen of an operating panel before a swipe operation in the third embodiment, and part (b) of FIG. 23 is a schematic view showing a screen of the operating panel during the swipe operation in the third embodiment.

### DESCRIPTION OF THE EMBODIMENTS

### First Embodiment

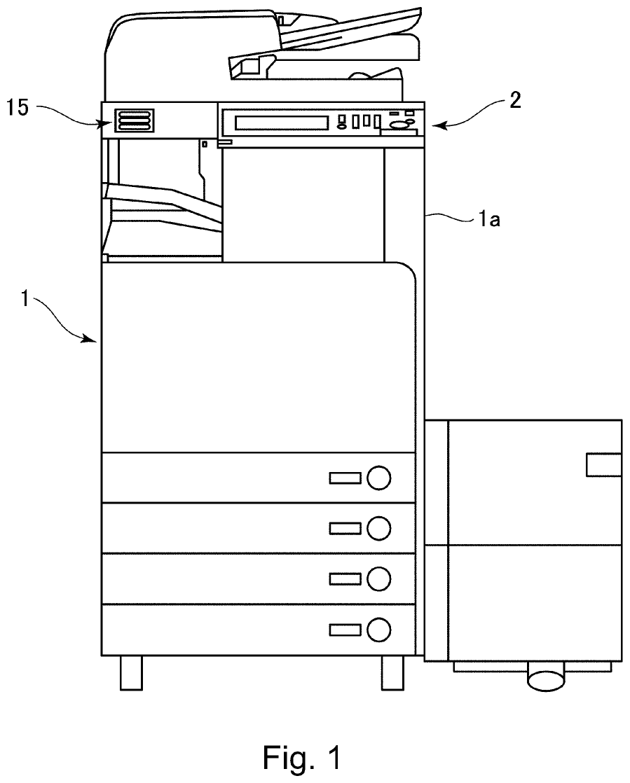

A first embodiment of the present invention will be described using FIGS. 1 to 19. First, a general structure of an image forming apparatus 1 of this embodiment will be described using FIGS. 1 to 4. The image forming apparatus 1 is, for example, a general multi-function machine possessing various functions such as a copy function, a scan function and a print function.

The image forming apparatus 1 of this embodiment enables allowance of use the image forming apparatus 1 including authentication of an operator by reading a two-dimensional bar code by a portable terminal 6 possessed by the operator such as a user or a service person or by establishing NFC between the portable terminal 6 and the image forming apparatus 1. For example, the image forming apparatus 1 authenticates the operator, so that the operator is capable of using the image forming apparatus 1. Further, the authenticated operator is capable of making setting of the image forming apparatus 1 peculiar to the operator him(her)self. Specifically, the operator can register a printing condition (image forming condition) such as setting of a sheet size, setting of color/monochromatic printing, setting of a print density (image density) and the like when printing (image formation) is carried out, in the image forming apparatus 1. By this, the image forming apparatus 1 authenticated the operator is capable of automatically retrieving the setting such as the printing condition peculiar to the authenticated operator. That is, the operator is capable of not only using the image forming apparatus 1 through the “authentication” but also using the image forming apparatus 1 without setting again the printing condition set by his(her)self in the past.

Here, the two-dimensional bar code principally has two types of functions consisting of the function of checking whether or not information on the user who intends to use the image forming apparatus 1 and information which has already been stored in the image forming apparatus 1 coincide with each other and the function of simply permitting the user to use the image forming apparatus 1. The former is a function used in an environment such as an office, for example. In the environment such as the office, users using the image forming apparatus 1 are limited to certain persons such as employees (of a company). For that reason, setting in the image forming apparatus can be made so that persons who are allowed to use the image forming apparatus are listed in advance and then the use of the image forming apparatus is allowed only to the listed persons. The latter is a function used in a public facility such as a convenience store or a library, for example. Persons using the image forming apparatus in such an environment are not identified. Accordingly, the image forming apparatus is used less in the above-described checking manner of use. Although specifically described later, the two-dimensional bar code is read in many instances in order to establish the wireless LAN connection. That is, when image data is sent to the image forming apparatus through wireless LAN such as Wi-Fi, the user is required to acquire “SSID” and “PASSWORD”, and therefore, the two-dimensional bar code is read.

Further, the image forming apparatus 1 of this embodiment enables wireless LAN connection between the portable terminal 6 and the image forming apparatus 1 by reading the two-dimensional bar code or by carrying out NFC. By this, for example, large volume communication of image data or the like in the portable terminal 6 is carried on by the wireless LAN, and an image based on this image data can be outputted by the image forming apparatus 1. This will be specifically described in the following.

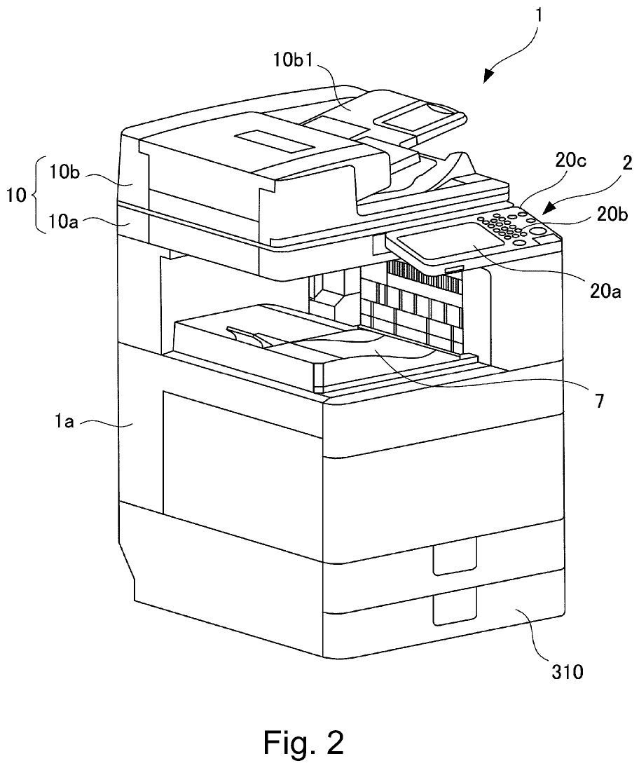

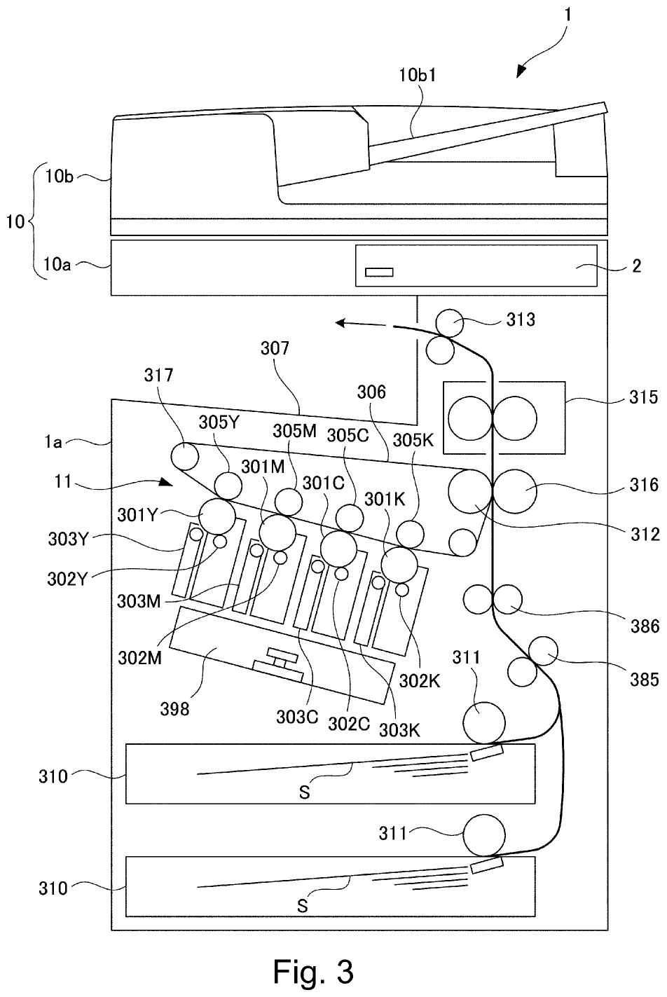

As shown in FIGS. 1 and 2, the image forming apparatus 1 includes an apparatus main assembly 1a incorporating therein an image forming unit 11 (FIG. 3) as an image forming portion for forming an image on a recording material, an operating panel 2 provided on a front sound of the apparatus main assembly 1a, and a human sensor 15 and the like. As the recording material, it is possible to cite a sheet such as paper, a plastic film, a cloth or the like. To the operating panel 2, an operation instruction by the operator such as the user such as an operator is inputted.

The image forming apparatus 1 of this embodiment is, as shown in FIG. 3, an image forming apparatus of an intermediary tandem type in which an image is formed by transferring toner images of four colors of yellow (Y), magenta (M), cyan (C) and black (K) onto an intermediary transfer belt and then by transferring the toner images onto the recording material. Incidentally, in the following description, to members using touches of the respective colors, suffixes Y, M, C and K are added. However, constitutions and operations of the respective members are substantially the same except that the colors of toners used are different from each other, and therefore, as regards the same constitution, a constitution for forming a yellow toner image is described as a representative, and constitutions of other colors will be omitted from description.

FIG. 2 is a schematic perspective view of the image forming apparatus 1. FIG. 3 is a schematic sectional view of the image forming apparatus 1. As shown in FIGS. 2 and 3, the image forming apparatus 1 includes the image forming unit 11 for forming the image on the recording material. The image forming unit 11 includes photosensitive drums 301Y, 301M, 301C and 301K, charging rollers 302Y, 302M, 302C and 302K, and developing devices 303Y, 303M, 303C and 303K. Further, the image forming unit 11 includes primary transfer rollers 305Y, 305M, 305C and 305K, a laser scanner unit 398, an intermediary transfer belt 306, a secondary transfer roller 316, a secondary transfer opposite roller 312, and the like.

The image forming apparatus 1 further includes an image reading unit 10 for reading an image of an original. The image reading unit 10 is constituted by a reader 10a and an ADF 10b. The reads 10a optically reads the image of the original placed on an unshown placement table formed with a glass plate and converts the image into image data. The ADF 10b automatically feeds original stacked on an original tray 10b1 and reads the image. The ADF 10b is rotatably supported and is opened upward by being rotated, whereby the user has access to the placement table of the reader 10a.

Further, on a front (surface) side of the image forming apparatus 1, an operating panel 2 capable of making setting on image formation and setting on image reading is provided. The operating panel 2 includes an operation display portion 20a capable of not only displaying information but also inputting information and providing an instruction to the image forming apparatus through touch operation, keys 20b for inputting numerical values and the like, and an outer casing cover 20c. The operation display portion 20a is capable of inputting information and providing the instruction to the image forming apparatus by displaying and touching software keys (touch operation) as described specifically later. The keys 20b as a manual input portion are hardware keys (physical keys) capable of inputting the information and providing the instruction to the image forming apparatus by displaying and touching the software keys. Incidentally, the keys 20b may also be omitted.

The operator is capable of inputting the information such as the numerical values and providing the instruction to the image forming apparatus by operating the operation display portion 20a or the keys 20b. Further, it is possible to make setting an image formation such as setting of a size of the recording material for image formation and the number of sheets subjected to image formation, and setting on reading of the image such as setting of an original size.

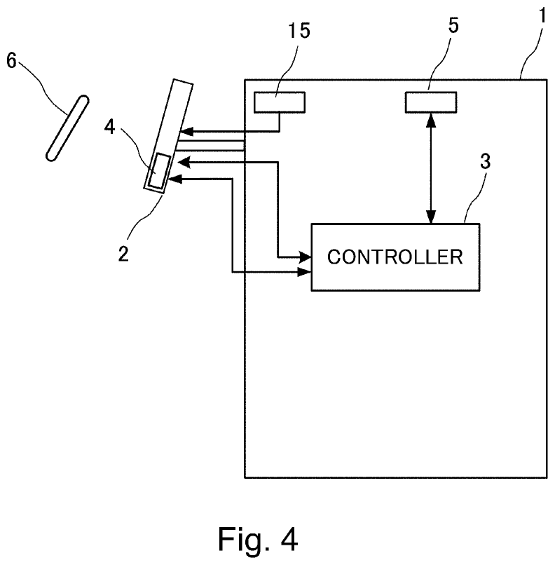

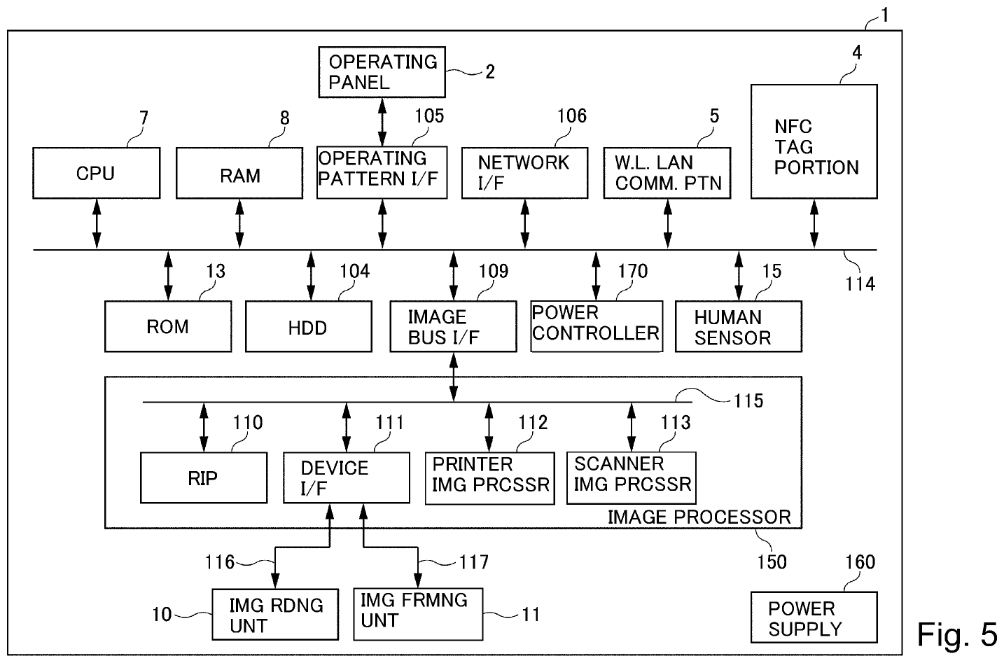

Next, an image forming operation by the image forming apparatus 1 will be described. When the image is formed, first, an image forming job signal is inputted to a CPU 7 of a controller 3 shown in FIGS. 4 and 5. By this, a feeding roller 311 and a conveying roller 385 are rotated, and the recording material stacked and accommodated in a cassette 310 is fed to a registration roller pair 386. Then, the recording material is sent at predetermined timing by the registration roller pair 386 to a secondary transfer portion formed by the secondary transfer roller 316 and the intermediary transfer belt 306 stretched by the secondary transfer opposite roller 312.

On the other hand, in the image forming unit 11, first, the sound of the photosensitive drum 301Y is electrically charged by the charging roller 302Y. Thereafter, in accordance with an image signal of an image of the original read by the image forming unit 10 or an image signal or the like sent from an external device such as a personal computer, the laser scanner unit 398 irradiates the sound of the photosensitive drum 301Y with laser light. By this, an electrostatic latent image is formed on the sound of the photosensitive drum 301Y. Thereafter, toner of yellow is deposited on the electrostatic latent image formed on the sound of the photosensitive drum 301Y by the developing device 303Y, so that a yellow toner image is formed on the sound of the photosensitive drum 301Y. The toner image formed on the sound of the photosensitive drum 301Y is primary-transferred onto the intermediary transfer belt 306 under application of a primary transfer bias to the primary transfer roller 305Y.

By a similar process, toner images of magenta, cyan and black are also formed on the photosensitive drums 301M, 301C and 301K, respectively. Then, by applying the primary transfer bias to the primary transfer rollers 305M, 305C and 305K, these toner images are superposedly transferred onto the yellow toner image on the intermediary transfer belt 306. By this, a full-color toner image depending on the image signal is formed on the sound of the intermediary transfer belt 306.

Thereafter, the intermediary transfer belt 306 is moved and circulated by transmission of a driving force from a driving roller 317 thereto, so that the full-color toner image is sent to the secondary transfer portion. Then, at the secondary transfer portion, by applying a secondary transfer bias to the secondary transfer roller 316, the full-color toner image on the intermediary transfer belt 306 is transferred onto the recording material S.

Then, the recording material on which the toner image is transferred is subjected to heating and pressing processes in a fixing device 315, whereby the toner image on the recording material is fixed on the recording material S. Thereafter, the recording material on which the toner image is fixed is discharged to a discharging portion 307 by a discharging roller pair 313.

As shown in FIG. 4, in the operating panel 2, a portable terminal (external device) 6 possessed by the operator and an NFC tag portion 4 for carrying out the NFC as near field wireless communication are provided. The NFC tag portion 4 is, as specifically described later, constituted by an antenna for carrying out transmission and reception of radio wave and an IC chip for controlling the NFC, and carries out the NFC, which is the near field wireless communication, between itself and the portable terminal such as a smartphone possessed by the operator. The NFC (near field communication) in a non-communication wireless communication standard utilizing electromagnetic radiation of 13.56 MHz. This standard is a short-range (distance) wireless (radio) communication standard which is represented by ISO/IEC 18092, ISO/IEC 21481 or the like and in which a communication distance is about 10 cm or less, and includes Felica (registered trademark) and Mifare (registered trademark) as representatives thereof. In this embodiment, Bluetooth (registered trademark) is also a kind of the near field wireless communication. In this embodiment, as an example of the near field wireless communication, an embodiment in which the NFC is carried out will be described.

Further, the image forming apparatus 1 is provided with a human sensor 15 for detecting the operator who approaches the image forming apparatus 1. The human sensor 15 is, for example, disposed at the front surface of the apparatus main assembly 1a, and in the case where a human (person) exists in front of the image forming apparatus 1, the human sensor 15 detects the human. Incidentally, the human sensor 15 may also be provided in the operating panel 2. For example, inside a slit formed in an outer casing cover 20c of the operating panel 2, the human sensor 15 is disposed, and ultrasonic wave is sent through the slit, so that reflected wave thereof is received and thus the operator may also be detected. Incidentally, a detailed constitution of the human sensor 15 will be described later.

Further, the image forming apparatus 1 is provided with a wireless LAN communication portion 5 for carrying out wireless LAN communication (wireless communication) with the portable terminal 6. The LAN is an abbreviation of “Local Area Network”. The NFC tag portion 4 and the wireless LAN communication portion 5 are connected to a controller 3 for controlling an operation of the image forming apparatus 1 through interfaces, respectively.

The portable terminal 6 is a device of a portable type, such as a smartphone or a computer of a tablet type or an IC card, and has functions of the NFC. In this embodiment, the portable terminal 6 is the device of the portable type, such as the smartphone or the computer of the table type, and includes a camera capable of reading the two-dimensional bar code. Further, the portable terminal 6 has the functions of the NFC and the wireless LAN communication. However, the portable terminal 6 does not have to possess the NFC function.

The operator carries out wireless communication with the image forming apparatus 1 by using the portable terminal 6 and causes the image forming apparatus 1 to execute various processes. Here, a range of the wireless LAN contact is broader than a range of the NFC. Further, a communicatable data volume per unit time in the wireless LAN communication is larger than a communicatable data volume per unit time in the NFC. For that reason, a communication speed during the wireless LAN communication is faster than a communication speed during the NFC. In other words, the NFC is slower in communication speed than the wireless LAN communication. The Wi-Fi communication is an example of the wireless LAN communication.

### [Controller]

Next, a system constitution of the image forming apparatus 1 will be described using FIG. 5. As shown in FIG. 5, the image forming apparatus 1 is provided with a RAM (memory) 8 in which data used for computation (calculation) by the CPU 7 is temporarily stored and with a ROM (storing device) 13 in which various programs are stored. Further, the image forming apparatus 1 is provided with an HDD 104 in which pieces of software and various settings relating to pieces of control of the image forming apparatus 1 and preserved documents are stored.

Further, the image forming apparatus 1 is provided with a network interface 106 for carrying out transmission and reception of data relative to an external device through the LAN and with the wireless LAN communication portion (wireless LAN interface) 5 for carrying out transmission and reception of data relative to the external device through the wireless LAN communication. Further, the image forming apparatus 1 is provided with an operating panel interface 105 for relaying input data through the operating panel 2 and image data to be displayed on the operating panel 2.

Further, the image forming apparatus 1 includes a power source (electric power) controller 170 for switching between supply of electric power to a particular device and stop of the supply by receiving an instruction from the CPU 7. The electric power controller 170 controls a power supply (device) 160 which receives supply of power source from a commercial power source and which is capable of supplying electric power by converting the power source into the electric power used in the respective devices. A detailed constitution of the electric power controller 170 will be described later. The above-described devices, NFC tag data 4 and human sensor 15 are connected to each other through a system bus 114.

Further, the image forming apparatus 1 includes the image processing portion 150 for processing the image. The image processing portion 150 is constituted by a RIP 110, a device interface 111, a printer image processing portion 112 and a scanner image processing portion 113, and these portions (elements) are connected to each other through an image bus 115. Further, the image bus 115 and the system bus 114 are constituted to each other through an image bus interface 109, and by the image bus interface 109, relay and data structure conversion between the image bus 115 and the system bus 114 are carried out.

The RIP 110 is a raster image processor converts a page-description language (PDL) code and a display list into bit mapped image. The scanner image processing portion 113 subjects image data read by the image reading unit 10 to image processing such as correction, resolution conversion and the like. The printer image processing portion 112 subjects image data formed by the image forming unit 11 to correction, resolution conversion and the like.

The image reading unit 10 is connected to the image bus 115 through a scanner bus 116 and the device interface 111. The image forming unit 11 is connected to the image bus 115 through a print bus 117 and the device interface 111. The device interface 111 adjusts timing when the image data received from the image reading unit is sent to the image bus 115 and timing when the image data is sent from the image bus 115 to the image forming unit 11.

### [Electric Power Controller]

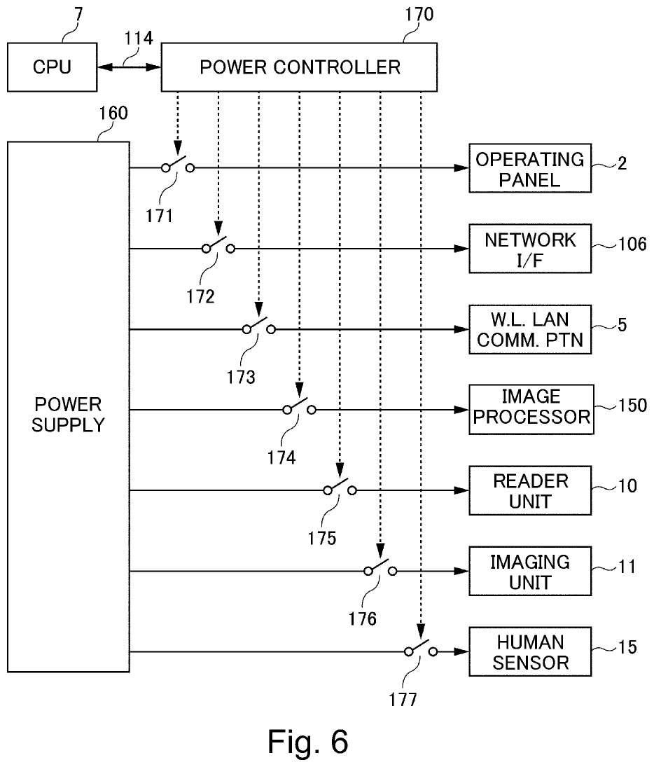

The detailed constitution of the electric power controller 170 will be described using FIG. 6. As shown in FIG. 6, the electric power controller 170 controls supply of electric power from the power supply 160 to respective devices and a stop of the supply of the electric power by switching ON and OFF of switches 171 to 177. Specifically, the electric power controller 170 controls the supply of the electric power and the stop of the electric power to the operating panel 2, the network interface 106, the wireless LAN communication portion 5, the image processing portion 150, the image reading unit 10, the image forming unit 11, and the human sensor 15. By this, in a state in which a main switch of the image forming apparatus 1 is turned on, the image forming apparatus 1 is capable of executing an operation in a stand-by state (mode) as a first mode in which the image forming apparatus 1 waits for the wireless LAN communication with the portable terminal 6 and an operation in a sleep mode as a second mode in which electric power consumption is smaller than electric power consumption in the operation in the stand-by state. This will be described in the following.

In the case where the image forming apparatus 1 is not used for a certain time or in the case where the operator selects a shift to the sleep mode by operating the operating panel 2 by the operator, the image forming apparatus 1 goes to the sleep mode for the purpose of saving electric power. In the sleep mode, the electric power controller 170 turns on the switches 172, 173 and 177 and turns off the switches 171, 174, 175 and 176. By this, drive of the operating panel 2, the image processing portion 150, the image forming unit 11 and the image reading unit 10.

In the case where an image forming job is designated through the network interface 106 in a state in which the image forming apparatus 1 is in a state of the sleep mode, the electric power controller 170 receives an instruction from the CPU 7 and switches the switches 174 and 176 to the “ON” state. This is also true for the case where the image forming job is designated through the wireless LAN communication portion 5. By this, the electric power is supplied to the image processing portion 150 and the image forming unit 11 which are used during execution of the image forming job, and the image forming apparatus 1 is restored from the sleep mode to the stand-by state.

Further, in the case where an image reading job is designated through the network interface 106 in a state in which the image forming apparatus 1 is in a state of the sleep mode, the electric power controller 170 receives an instruction from the CPU 7 and switches the switches 174 and 175 to the “ON” state. This is also true for the case where the image reading job is designated through the wireless LAN communication portion 5. By this, the electric power is supplied to the image processing portion 150 and the image reading unit 10 which are used during execution of the image reading job, and the image forming apparatus 1 is restored from the sleep mode to the stand-by state.

Thus, in the case where the job is designated from the network interface 106 or the wireless LAN communication portion 5, the CPU 7 controls the electric power controller 170 so that the electric power is supplied only to the device(s) used during execution of the job. By this, electric power consumption during the execution of the job of the image forming apparatus 1 is suppressed.

Further, in the case where the operator who approaches the image forming apparatus 1 is detected by the human sensor 15 in the state in which the image forming apparatus 1 is in the state of the sleep mode, the electric power controller 170 receives an instruction from the CPU 7 and then switches the switches 171, 174, 175 and 176 to the “ON” state. By this, the image forming apparatus 1 is restored from the sleep mode to the stand-by state. The reason why all the switches 171 to 177 are turned on in the case where the operator is detected by the human sensor 15 as described above is that the job designated by the operator detected by the human sensor 15 is unclear and therefore convenience is enhanced by putting all the devices in the stand-by state.

Further, in the case where the wireless LAN communication with the portable terminal 6 is not permitted in the state in which the image forming apparatus 1 is in the state of the sleep mode, when the operator is detected by the human sensor 15 or the like and the image forming apparatus 1 is in the stand-by state, the CPU 7 waits for the wireless LAN communication with the portable terminal 6.

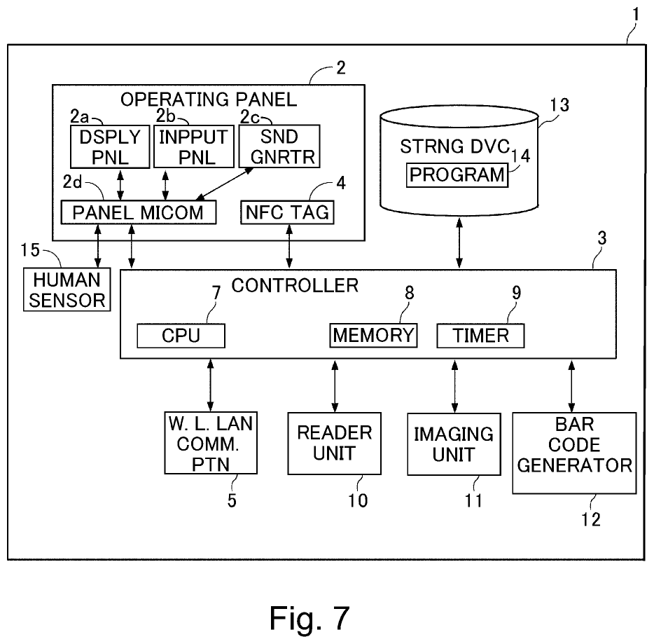

That is, the stand-by state is a state in which the CPU 7 waits for the wireless LAN communication with the portable terminal 6. Further, the stand-by state is also a state in which the CPU 7 waits for reception of the image data from the portable terminal 6. Further, the stand-by state may also be, for example, a state in which electric power supply to the respective portions of the image forming apparatus 1 is carried out and in which image formation or image reading can be carried out immediately in accordance with the operation by the operator. That is, the stand-by state may also be a state in which the image forming apparatus 1 waits for the image formation or the image reading. On the other hand, the sleep mode is, for example, an electric power saving state in which electric power consumption is made lower than electric power consumption in the stand-by state by stopping the electric power supply to the respective portions such as the operating panel 2. In this embodiment, in the sleep mode, although the display portion 2a (FIG. 7) of the operating panel 2 is kept turned off, it may only be required that at least electric power supply to the human sensor 15 is carried out.

For example, the operating panel 2 is provided with a button for eliminating (releasing) the sleep mode and then the sleep mode may also be eliminated by operating this button, or may also be eliminated by operating any button of keys 20b (FIG. 2). Alternatively, the sleep mode may also be eliminated by touching the operation display portion 20a (FIG. 2). In these cases, even in the sleep mode, the electric power is supplied to the keys 20b or the operation input portion 2b, and the operating panel micron 2d (FIG. 7), and is not supplied to at least the display portion 2a (FIG. 7).

### [Hardware Constitution of Image Forming Apparatus]

Next, a detailed relationship between the controller 3, the operating panel 2 and the human sensor 15 will be described using FIG. 7. FIG. 7 is a block diagram showing a part of a hardware constitution of the image forming apparatus 1. The image forming apparatus 1 includes the operating panel 2, the image reading unit 10 for reading the original and for generating the image data, the image forming unit 11 for executing an image forming process on the basis of the image data, a two-dimensional bar code generating portion 12, a storing device (ROM) 13 for storing various pieces of information. Further, the image forming apparatus 1 includes the NFC tag portion 4, provided in the operating panel 2, for performing the above-described NFC and includes the wireless LAN communication portion 5. These portions are connected to each other through interfaces.

The controller 3 includes the CPU 7, a memory (RAM) 8 and a timer 9, and controls operations of the respective portions. The CPU 7 reads a program 14 stored in the storing device 13 and executes the program 14. The program 14 is a program causing the controller 3 to function for performing various processes described later. The memory 8 is used for storing temporary data with execution of the program by the CPU 7. The timer 9 is used for timing when the controller 3 performs the various processes. Further, the controller 3 also functions as a permitting (allowing) portion for permitting (allowing) the wireless LAN communication with the portable terminal on the basis of the NFC as described later.

The operating panel 2 includes the operating panel display portion 20a (FIG. 2) for permitting the operator to perform the operation as described above, the keys 20b (FIG. 2), an operation sound generating portion 2c, an operating panel micron 2d, and the NFC tag portion 4. The operating panel display portion 20a includes the display portion 2a and the operation input portion 2b as an operating portion and a manual input portion. The display portion 2a is constituted by, for example, a liquid crystal panel and is capable of displaying various pieces of information. The display portion 2a is capable of displaying an image on the liquid crystal panel, for example, by receiving the image data from the controller 3 through an unshown transfer line for image data.

The operation input portion 2b is a touch panel or the like provided on the display portion 2a, and the user is capable of inputting information by a touch operation. Incidentally, a constitution in which an LED for displaying a state of the image forming apparatus 1 on the operating panel 2. The LED is abbreviation of “Light Emitting Diode”.

In this embodiment, the operation input portion 2b is a touch panel such that software keys are displayed at the display portion 2a and the user is capable of inputting the information by the toner operation of the software keys. The operation sound generating portion 2c is used for generating various operation sounds with operations. The operating panel micron 2e control these portions and communicates with the controller 3.

The NFC tag portion 4 performs the NFC with the external device (the portable terminal 6 in this embodiment) on the basis of the NFC standard, and thus carries out data input and output between the portable terminal 6 and the controller 3. The NFC tag portion 4 in this embodiment is constituted by an IC for RFID (Radio Frequency Identification) and operates as an NFC tag.

The human sensor 15 is capable of detecting the presence of a human (person) within a predetermined region of a periphery of the image forming apparatus 1. The human sensor 15 in this embodiment in a sensor for detecting the human or an object present in front of the image forming apparatus 1, and then sends a detection signal to the operating panel micron 2d. For example, when the human sensor 15 detects the human in the case where the image forming apparatus 1 is in a sleep mode, the controller 3 causes the image forming apparatus to shift its state from the sleep mode to the stand-by state. That is, when a state of the display portion shifts from an off-state to an on-state, the reading image is displayed on the display portion 2a. By this, the operator such as the user is capable of reading the reading image by the portable terminal 6 immediately after the state of the image forming apparatus 1 is restored from the sleep mode to the stand-by state.

The wireless LAN communication portion 5 performs processing of the wireless LAN communication with the external device (the portable terminal 6 in this embodiment) on the basis of the wireless LAN standard, and thus performs data input and output carried out between the portable terminal 6 and the controller 3. Specifically, the wireless LAN communication portion 5 performs processing of transmission and reception of data packets in accordance with a wireless LAN communication procedure. Incidentally, the wireless LAN communication portion 5 in this embodiment is compatible with a wireless LAN direct mode.

In the wireless LAN direct mode, the wireless LAN communication portion 5 operates as a wireless LAN access point (software access point), whereby the wireless LAN communication portion 5 is capable of carrying out the wireless LAN communication with the external device such as the portable terminal 6 without through an external wireless LAN access point.

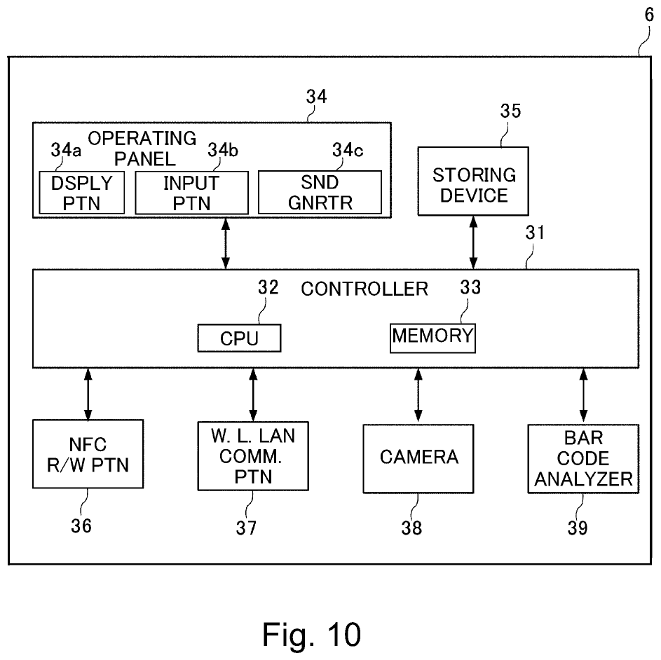

The two-dimensional bar code generating portion 12 generates (forms) an image of a two-dimensional bar code by encoding set data into a two-dimensional bar code (QR code (registered tradename)) as the reading image. The generated image of the two-dimensional bar code can be read by being displayed at the display portion 2a of the operating panel 2 and then by use of the portable terminal 6 by the user. Incidentally, the reading image is an image which is readable by a camera 38 (FIG. 10) of the portable terminal 6 and which contains information for permitting the wireless LAN communication with the image forming apparatus 1. Further, the reading image may also be an image for authentication containing information for authenticating the user by the image forming apparatus. In this embodiment, the reading image is the two-dimensional bar code, but when such an image is used, the image for authentication is not limited to the two-dimensional bar code.

### [Hardware Constitution of NFC Tag Portion]

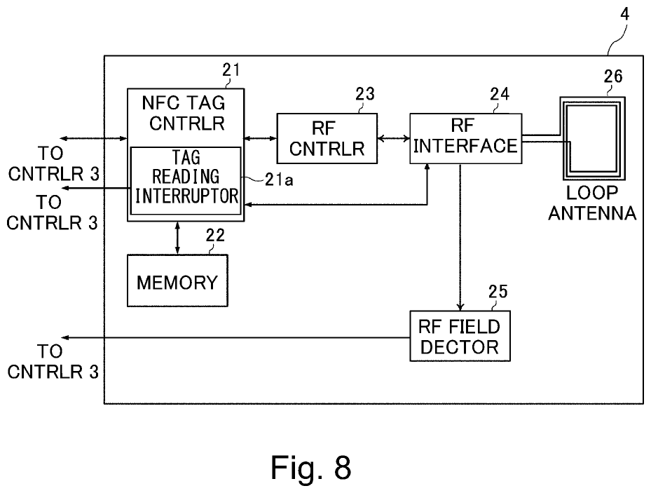

Next, by using FIG. 8, a hardware constitution of the NFC tag portion 4 in the image forming apparatus 1 will be described. The NFC tag portion 4 includes an NFC tag controller 21, a memory 22, an RF controller 23, an RF interface portion 24, an RF field detecting portion 25, a loop antenna 26, and the like.

The NFC tag controller 21 carries out control of the respective portions of the NFC tag portion 4 and thus performs data input and output relative to the controller 3 through interfaces. The NFC tag controller 21 includes a tag reading interruption generating portion 21a.

The tag reading interruption generating portion 21a generating an interruption signal when reading and writing of the NFC tag data relative to the portable terminal 6 by the NFC between itself and the portable terminal 6 are carried out. The interruption signal of the tag reading interruption generating portion 21a is outputted to the controller 3.

The memory 22 accumulates, as the NFC tag data, data written from the controller 3 or the portable terminal 6, and is constituted by a non-volatile memory. Further, the data written in the memory 22 is capable of being read by the controller 3.

The RF controller 23 performs modulation and demodulation processes of electromagnetic radiation for RF communication when the NFC thereof with the external device (the portable terminal 6 in this embodiment). The RF is an abbreviation of “Radio Frequency”.

When the RF interface portion 24 performs the NFC with the external device (the portable terminal 6 in this embodiment), the RF interface portion 24 carries out electromagnetic coupling by being subjected to radiation of electromagnetic radiation, and thus performs transmission and reception processes of the electromagnetic radiation.

The RF field detecting portion 25 detects an electromagnetic field (RF field) in a period in which the RF interface portion 24 is subjected to the radiation of the electromagnetic radiation in the NFC with the external device.

Specifically, the RF field detecting portion 25 detects electric power (energy) of the electromagnetic radiation. Incidentally, a detection signal of the RF field detecting portion 25 is outputted to the controller 3.

The loop antenna 26 is an antenna for carrying out the NFC with the external device and is formed in a loop coil shape in order that in this embodiment, communication by the electromagnetic radiation is carried out by subjecting the loop antenna 26 to the radiation of electromagnetic radiation from the portable terminal 6 and by carrying out electromagnetic coupling.

In this embodiment, the NFC tag portion 4 performs electromagnetic coupling by being subjected to the radiation of electromagnetic radiation from the portable terminal 6 and then operates by being supplied with electric power resulting from electromotive force generated by the electromagnetic coupling. Incidentally, the memory 22, the RF controller 23 and the RF interface portion 24 are controlled by the NFC tag controller 21.

### [Operating Panel]

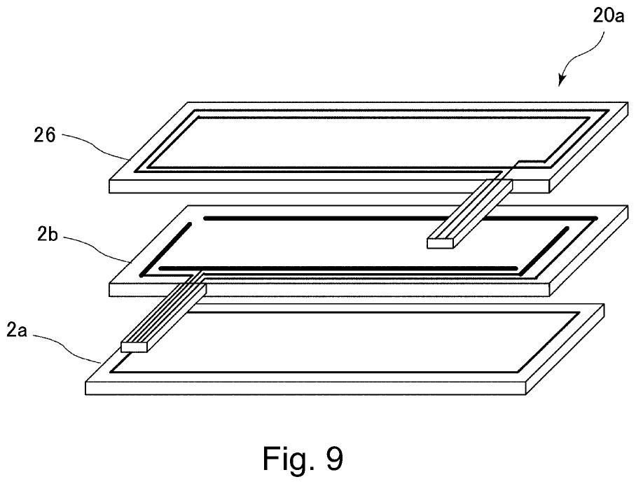

Next, by using FIG. 9, the operation display portion 20a of the operating panel 2 will be described more specifically. In this embodiment, the operation display portion 20a incorporates an NFT antenna, and from a lowermost layer, the display portion 2a, the operation input portion 2b which is a touch panel, and the loop antenna 26 which is the NFC antenna are superposedly disposed in a named order. At an outermost portion, as shown protective glass may also be provided.

That is, as the lowermost layer of the operation display portion 20a, the display portion 2a such as a liquid crystal is disposed. The display portion 2a and the operating panel micron 2d (FIG. 7) are connected to each other by an unshown flexible flat cable (hereinafter, referred to as FFC) or the like. On the display portion 2a, the operation input portion 2b such as the touch panel is disposed. Incidentally, in the operating panel 2, “On the display portion 2a” refers to a side where the operator touches the operating panel 2.

The operation input portion 2b may also be a touch panel of a resistance type or an electrostatic capacity type or may also be an optical structure, but in this embodiment, a four-wire resistance-type touch panel is used.

As regards the touch panel as the operation input portion 2b, electrodes are provided on four sides and each of the electrodes is connected to the operating panel micron 2d through a connector such as a flexible printed circuit (hereinafter, abbreviated as FPC).

On the operation input portion 2b, the loop antenna 26 which is an antenna pattern of the NFC is disposed. The operation input portion 2b and the loop antenna 26 are transparent or semi-transparent films, so that an image displayed on the display portion 2a is visible from above the loop antenna 26.

In this embodiment, the loop antenna 26 is a single antenna pattern, but may also be constituted by a plurality of antenna patterns. The loop antenna 26 is also connected to the RF interface portion 24 through a connector such as the FPC.

The loop antenna 26 is most sensitive when the loop antenna 26 is disposed on the operation input portion 2b in communication with the portable terminal 6. For this reason, in this embodiment, the loop antenna 26 is disposed so as to cover the operation input portion 2b. Incidentally, a position of the loop antenna 26 is not limited thereto, but may also be disposed between the display portion 2a and the operation input portion 2b, for example. Further, the loop antenna 26 and the operation input portion 2b may also be constituted integrally with each other.

In this embodiment, thus, the loop antenna 26 which is the antenna for establishing the NFC is disposed in the operating panel 2 so as to be superposed on the display portion 2a. For this reason, although described specifically later, a touch screen such that the operator is guided to a predetermined position on the operating panel 2 within a display range so as to hold the portable terminal 6 over the predetermined position can be displayed at the display portion 2a. Then, the operator holds the portable terminal 6 over the operating panel 2, so that the user is capable of carrying out the SFC.

### [Hardware Constitution of Portable Terminal]

Next, by using FIG. 10, a hardware constitution of the portable terminal 6 will be described. The portable terminal 6 includes a controller 31, to an operating panel 34, a storing device 35, an NFC R/W portion 36, a wireless LAN communication portion 37, a camera 38, a two-dimensional bar code analyzing portion 39 and the like. The controller 31 controls the portable terminal 6 and is constituted by the CPU 32 and the memory 33. The CPU 32 reads and executes various programs stored in the storing device 35. The memory 33 stores temporary data with execution of the program by the CPU 32.

The operating panel 34 has a constitution in which the operator inputs an operation instruction thereto. That is, the operating panel 34 is constituted by a display portion 34a, constituted by a liquid crystal panel, for displaying various pieces of information and an operation input portion 34b which is provided on the display portion 34a and which is a touch panel or the like. In addition, the operating panel 34 includes an operation sound generating portion 34c for generating various operation sounds with various operations. The storing portion 35 stores the above-described various programs and the like.

The NFC R/W portion 36 performs the NFC with the external device (the image forming apparatus 1 in this embodiment) on the basis of the NFC standard and carries out data input and output performed between the image forming apparatus 1 and the controller 3. The NFC R/W portion 36 in this embodiment operates as an NFC reader/writer. That is, the NFC R/W portion 36 reads and writes data through the NFC.

The wireless LAN communication portion 37 performs a communication process with the external device (image forming apparatus 1 in this embodiment) on the basis of the wireless LAN standard, and carries out data input and output performed between the image forming apparatus 1 and the controller 31. The wireless LAN communication portion 37 in this embodiment performs a process of the wireless LAN communication on the basis of the wireless LAN standard, and specifically performs processes of transmission and reception of data packets in accordance with a wireless LAN communication procedure.

The camera 38 is a camera for image pickup. The two-dimensional bar code 39 analyzes a read two-dimensional bar code and acquires data of the two-dimensional bar code. Further, although not illustrated, the portable terminal 6 includes a constitution of electric power supply necessary for the portable terminal 6, such as a battery and a power source (electric power) controller.

### [Hardware Constitution of NFC R/W Portion]

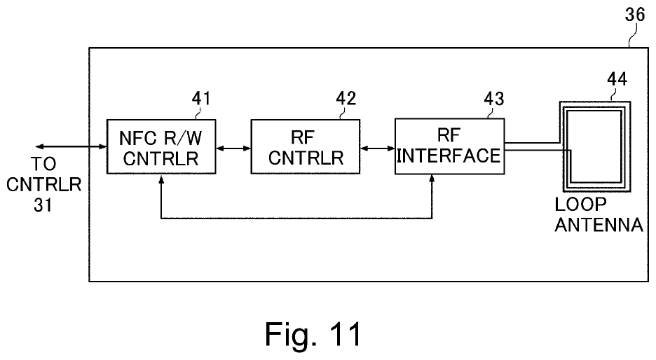

Next, by using FIG. 11, a hardware constitution of the NFC R/W portion 36 will be described. The NFC R/W portion 36 includes an NFC R/W controller 41, an RF controller 42, an RF interface portion 43, a loop antenna 44 and the like.

The NFC R/W portion 41 controls the respective portions of the NFC R/W portion 36 and carries out data input and output relative to the controller 31 through the interfaces. The RF controller 42 performs modulation and demodulation of electromagnetic radiation for RF communication when the RF controller 42 performs the NFC with the external device. The RF interface portion 43 radiates the electromagnetic radiation and carries out electromagnetic coupling when performs the NFC with the external device. The RF interface portion 43 radiates electromagnetic radiation (wave) and performs electromagnetic coupling when carries out the NFC with the external device, so that the RF interface portion 43 carries out processes of transmission and reception of the electromagnetic radiation.

The loop antenna 44 is an antenna for performing the NFC with the external device, and in this embodiment, is formed in a loop coil shape for carrying out communication through the electromagnetic radiation by radiating the electromagnetic radiation to the image forming apparatus 1 and by carrying out the electromagnetic coupling. Incidentally, the RF controller 42 and the RF interface portion 43 are controlled by the NFC R/W controller 41.

### [NFC]

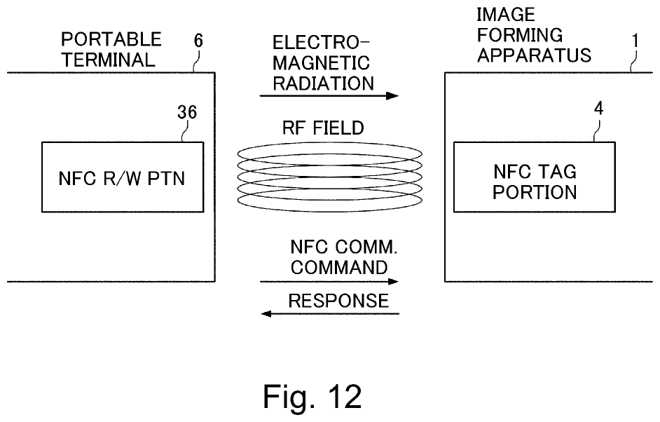

Next, by using FIG. 12, an operation such that the NFC R/W portion 36 of the portable terminal 6 carries out electromagnetic coupling with the NFC tag portion 4 of the image forming apparatus 1 and thus reads NFC tag data of the NFC tag portion 4 through the NFC will be described. Incidentally, a detailed communication protocol of the NFC conforms to the NFC standard, and in the following, an operation outline of the NFC by the electromagnetic coupling will be described.

First, the NFC R/W portion 36 performs a polling operation for reading the NFC tag data of the NFC tag portion 4. Then, the operator holds the portable terminal 6 and brings the NFC R/W portion 36 of the portable terminal 6 near to the NFC tag portion 4 of the image forming apparatus 1. That is, the operator brings the portable terminal 6 near to or contact with a predetermined position of the operating panel 2.

The NFC R/W controller 41 controls the RF controller 42 and modulates the electromagnetic radiation on the basis of the NFC standard in order to send command data for reading the NFC tag. This modulated wave is sent to the RF interface portion 43. The NFC R/W controller 41 controls the RF interface portion 43 and sends the modulated wave.

The sent modulated wave is sent to the loop antenna 44 from the RF interface portion 43 and is radiated as the electromagnetic radiation. By this radiated electromagnetic radiation, in the neighborhood of the NFC R/W portion 36 and the NFC tag portion 4, an RF field is formed, so that the NFC R/W portion 36 and the NFC tag portion 4 are electromagnetically coupled to each other.

The NFC tag portion 4 receives the electromagnetic radiation by subjecting the loop antenna 26 to radiation of the electromagnetic radiation. The received electromagnetic radiation is sent to the RF interface portion 24, and the RF interface portion 24 generates electromotive force due to the electromagnetic coupling. By this electromotive force, the NFC tag portion 4 obtains electric power and thus operates. At the same time, the electromagnetic radiation received by the RF interface portion 24 is sent to the RF controller 23.

The NFC tag controller 21 controls the RF controller 23 and acquires demodulated data by demodulating the modulated electromagnetic radiation sent to the RF controller 23. The NFC tag controller 21 thus acquires the demodulated data and detects that this demodulated data is command data for reading the NFC tag data.

Therefore, the NFC tag controller 21 reads the data written as the NFC tag data in the memory 22 and transfers, to the RF controller 23, the data as response data to command data. The NFC tag controller 21 controls the RF controller 23 and modulates the ER on the basis of the NFC standard in order to send the response data which is the NFC tag data, so that this modulated wave is sent to the RF interface portion 24.

The NFC tag controller 21 controls the RF interface portion 24 and sends a resultant modulated wave. The sent modulated wave is sent from the RF interface portion 24 to the loop antenna 26, and then is radiated as the electromagnetic radiation. At this point of time, the NFC tag controller 21 regards the NFC tag data as that sending of the NFC tag data as the response data is completed in response to reception of the command data for reading the NFC tag data, and generates an interruption signal by the tap reading interruption generating portion 21a.

On the other hand, in the NFC R/W controller 41, the loop antenna 44 receives the modulated electromagnetic radiation on the basis of the response data radiated from the NFC tag controller 21. The received electromagnetic radiation is sent to the RF controller 42 through the RF interface portion 43.

The NFC R/W controller 41 controls the RF controller 42 acquires the demodulated data by demodulating the modulated electromagnetic radiation sent to the RF controller 42. Then, the NFC R/W controller 41 notifies the controller 31 of that reading of the NFC tag data of the NFC tag portion 4 is completed. At the same time, the NFC R/W controller 41 transfers the read NFC tag data to the controller 31.

When notification to the effect that the reading of the NFC tag data from the NFC R/W controller 41 of the NFC P/W portion 36 in the portable terminal 6 is completed is received by the controller 31, the controller 31 causes the operation sound generating portion 34c of the operating panel 34 to generate an operation completion sound.

By this, the operator is capable of knowing that the reading of the NFC tag data of the NFC tag portion 4 in the image forming apparatus 1 by the NFC R/W portion 36 of the portable terminal 6 is completed.

Incidentally, also in the case where the NFC tag portion 4 of the image forming apparatus 1 acquires the data of the NFC R/W portion 36 of the portable terminal 6, a communication method is similar to the above communication method since a data output side and a data reading side are only reversed.

Here, pieces of information such as “ID” and “PASSWORD” which are pieces of setting information for carrying out operator authentication (individual personal authentication, log-in) and permission of use of the image forming apparatus by the portable terminal 6 are stored in the storing device 35 of the portable terminal 6. As regards reading of the data from the NFC tag portion 4, the NFC R/W portion 36 of the portable terminal 6 outputs as the NFC tag data, the above-described pieces of information read from the storing device 35. By this, the image forming apparatus 1 is capable of acquiring the setting information necessary for the individual authentication and the permission of use, and authenticates the user possessing the portable terminal 6 and permits the operator to use the image forming apparatus 1. Incidentally, the image forming apparatus 1 permits the operator to use the image forming apparatus 1 also by authenticating the operator. The permission of use of the image forming apparatus 1 referred to herein includes formation of the image on the recording material, permission of use of an original reading apparatus, and in addition, permission of the wireless LAN communication and the like.

Incidentally, pieces of setting information such as SSID, PASSKEY, and IP address, which are pieces of setting information for carrying out an operation in a wireless LAN direct mode are stored in the storing device 13 of the image forming apparatus 1. In the memory 22 of the NFC tag portion 4 of the image forming apparatus 1, the pieces of setting information such as the SSID, the PASSKEY and the IP address which are read from the storing device 13 are stored. As regards reading of the data from the NFC R/W portion 36 of the portable terminal 6, the NFC tag portion 4 of the image forming apparatus 1 outputs, as the NFC tag data, the above-described pieces of setting information read from the memory 22. By this, the portable terminal 6 is capable of acquiring the setting information necessary for the wireless LAN connection, so that the image forming apparatus 1 authenticates the operator possessing the portable terminal 6, and carries out the wireless LAN connection with this portable terminal 6 and simply permits the operator to establish connection of the wireless LAN communication.

Thus, in the case of this embodiment, the operator holds the portable terminal 6, compatible with the NFC, over the NFC tag portion 4 on the image forming apparatus 1 side, whereby the image forming apparatus 1 and the portable terminal 6 acquire the pieces of connection information for the individual authentication and the wireless LAN connection. Then, the image forming apparatus 1 automatically makes settings of the individual authentication and the wireless LAN connection.

### [Human Sensor]

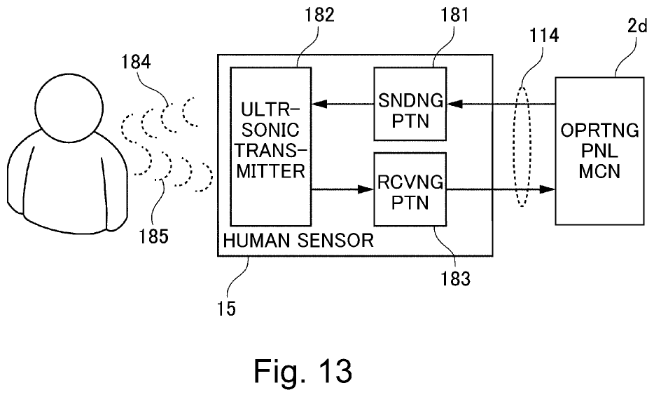

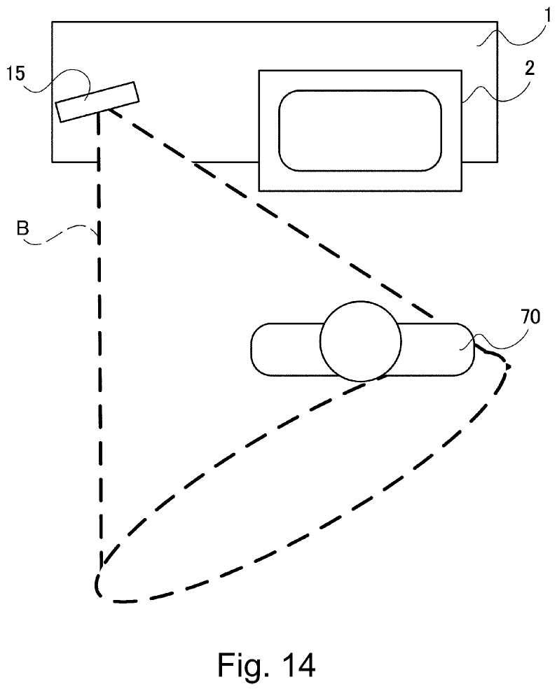

Next, by using FIGS. 13 and 14, the human sensor 15 will be described. FIG. 13 is a block diagram showing a constitution of the human sensor 15. As shown in FIG. 13, the human sensor 15 is constituted by a transmitting (sending) portion 181, a receiving portion 183 and an ultrasonic transmitting and receiving element (device) 182. The ultrasonic transmitting and receiving element 182 converts an electric signal into ultrasonic wave and target marks (sends) the ultrasonic wave, or receives the ultrasonic wave and converts the ultrasonic wave into the electric signal.

The transmitting portion 181 receives a digital signal for controlling ultrasonic transmission, from the operating panel micron 2d and converts the digital signal to an analog signal for performing the ultrasonic transmission by the ultrasonic transmitting and receiving element 182. When the ultrasonic transmitting and receiving element 182 receives the electric signal of the ultrasonic transmission from the transmitting portion 181, the ultrasonic transmitting and receiving element 182 oscillates and transmits ultrasonic wave. A transmission wave 184 of the ultrasonic wave transmitted from the ultrasonic transmitting and receiving element 182 is reflected when the transmission wave 184 impinges on an object such as a human body. A reflected wave 185 of this ultrasonic wave is received by the ultrasonic transmitting and receiving element 182, and the ultrasonic transmitting and receiving element 182 inputs the reflected wave 185 as an analog electric signal to the receiving portion 183.

The receiving portion 183 converts the analog electric signal of the received ultrasonic wave to a digital signal, and inputs the digital signal to the operating panel micron 2d through the system bus 114. The operating panel micron 2d measures a time from transmission of a signal for controlling the ultrasonic transmission to the transmitting portion 181 until the receiving portion 183 receives a reception signal of the reflected wave 185 of the ultrasonic wave. Then, from a dynamic change of this time, the operating panel micron 2 detects motion such that the object generating the reflected wave 185 moves toward and away from the object. Incidentally, the operating panel micron 2d which is an object for transmitting the signal to the human sensor 15 and for receiving the signal from the human sensor 15 may also be the CPU 7 of the controller 3.

FIG. 14 shows a positional relationship between a detection range (predetermined region) B of the human sensor 15 and an operator 70. In this embodiment, the human sensor 15 is an ultrasonic sensor as described above. The detection range B of the human sensor 15 diverges from a detection surface of the human sensor 15 toward the front of the image forming apparatus 1 in a sector shape.

When the operator 70 walks in a direction of the image forming apparatus 1 and approaches the image forming apparatus 1 and enters the detection range of the human sensor 15 as shown in FIG. 14, a detection signal of the human sensor 15 changes. The operating panel micron 2d (FIG. 7) detects the object along an object detection algorithm in accordance with the change in detection signal of the human sensor 15.

In the ultrasonic sensor in this embodiment also receives signals reflected by immovable objects such as a desk and a pillar and the like placed on the periphery of the image forming apparatus, and therefore, by the detection algorithm, the operator 70 approaching the image forming apparatus 1 is discriminated. Further, by the detection algorithm, discrimination between a person who only crosses the front of the image forming apparatus 1 and a person who actually uses the image forming apparatus 1 is made.

In the case where the operating panel micron 2d detects the operator 70 in accordance with the detection algorithm, the operating panel micron 2d transmits a detection signal thereof to the controller 2. In accordance with the detection signal, the CPU 7 of the controller 3 carries out control of operations such that a power supply state of the image forming apparatus 1 is changed from the sleep state (mode) to the stand-by state and such that the stand-by state is maintained so as not to shift to the sleep state. That is, when the human sensor 15 detects a person in a state in which the image forming apparatus 1 is in the sleep state, the CPU 7 causes the image forming apparatus 1 to shift its state from the sleep state to the stand-by state. Then, during the detection of the person by the human sensor 15, the CPU 7 does not cause the image forming apparatus 1 to shift its state to the sleep state.

Incidentally, when the human sensor 15 does not detect the person, the CPU 7 may also cause the image forming apparatus 1 to automatically shift its state to the sleep state. Further, even when the human sensor 15 detects the person in the stand-by state, in the case where there is no operation of the image forming apparatus 1 by the operator 70 for a certain time, the CPU 7 may also cause the image forming apparatus 1 to shift its state to the stand-by state.

### [Authentication of Operator by Two-Dimensional Bar Code]

Next, an outline of an operation in which the operator reads the two-dimensional bar code displayed on the image forming apparatus 1, by the portable terminal 6 and then acquires data information from the image forming apparatus 1. The image forming apparatus 1 of this embodiment is also compatible with hand-over to the wireless LAN direct connection by reading of the two-dimensional bar code as an alternative means of hand-over to the wireless LAN direct connection by reading of the above-described NFC tag.

Conventionally, a constitution in which in order to display the two-dimensional bar code on a display portion of the image forming apparatus, the operator operates plural times the operation input portion of the operating panel of the image forming apparatus in many instances. Thus, when the operator operates the operating panel plural times, the image forming apparatus encodes setting data in the two-dimensional bar code by using the two-dimensional bar code generating portion and generates a two-dimensional bar code image.

For example, conventionally, the operator performs a plurality of operations sequentially from “Mobile” to “QR display” in a top menu screen through the operating panel. Then, pieces of information of SSID, PASSKEY and IP address which are pieces of setting information necessary to carry out the wireless LAN direct communication and communication with the image forming apparatus are generated as a two-dimensional bar code image, and the two-dimensional bar code image is displayed on the operating panel. On the other hand, the operator reads the two-dimensional bar code image with a camera incorporated in the portable terminal. The read two-dimensional bar code image is restored as an original setting data by being analyzed by the two-dimensional bar code analyzing portion. The portable terminal reads the two-dimensional bar code image displayed on the image forming apparatus in the above-described manner and acquires the setting information, and thus is capable of hand-over to the wireless LAN direct connection.

In this embodiment, in order to improve operativity by the operator, the two-dimensional bar code is displayed without operating the operating panel plural times. Description relating to the hand-over to the wireless LAN direct connection other than the aforementioned description is similar to the description in the conventional constitution.

### [Control Relating to Wireless LAN Connection]

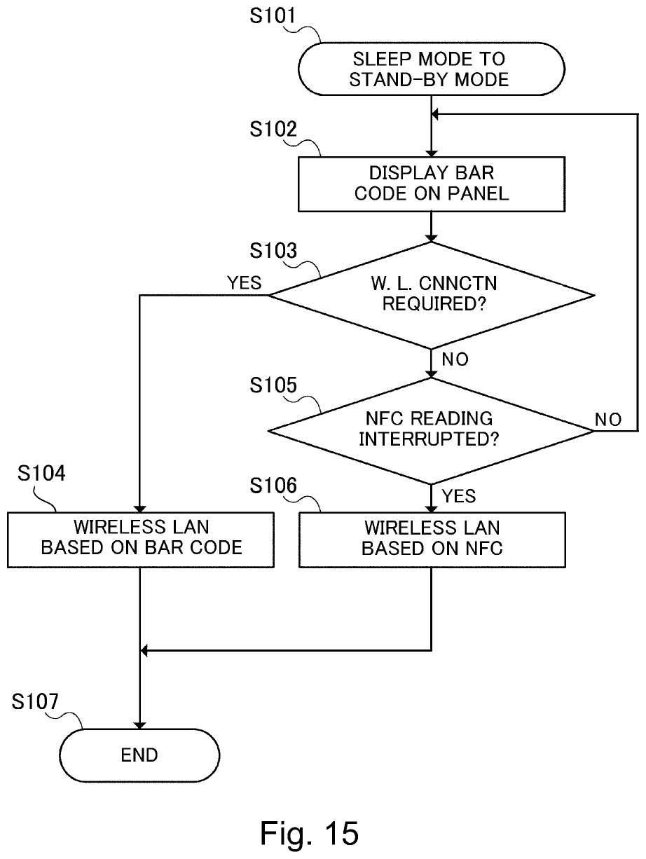

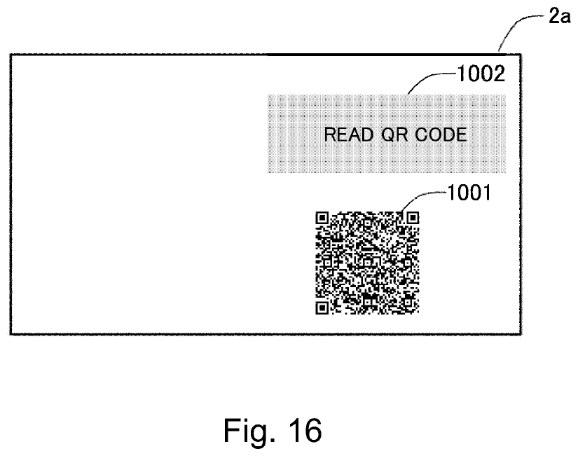

Next, control relating to the wireless LAN connection in this embodiment will be described by using FIGS. 15 and 16. In the following description, the operator is the user. Incidentally, the operator is not limited to the user, but includes a service person for carrying out maintenance of the image forming apparatus 1.

First, it is assumed that the image forming apparatus 1 is in the sleep mode (state). Further, for example, when the human sensor 15 detects the person, the state of the image forming apparatus 1 is restored from the sleep mode to the stand-by state (S101). Then, the CPU 7 causes the operating panel 2 to display the two-dimensional bar code as a reading image on a screen of the display portion 2a (S102).

At this time, the portable terminal 6 and the image forming apparatus 1 are in a state in which the wireless LAN connection therebetween is not established. For example, image data designated by an application or the like of the portable terminal 6 is sent to the image forming apparatus 1 and is printed out by the image forming apparatus in some instances, but in the stand-by state, the image data is not sent to the image forming apparatus 1. In this case, the camera of the portable terminal 6 reads the two-dimensional bar code and thereafter in response to establishment of the wireless LAN connection by the Wi-Fi or the like, the image data is sent from the portable terminal 6 to the image forming apparatus 1. That is, the stand-by state is a state in which a main switch is turned on, but as regards the image data, the stand-by state is a state in which the image data is not received from the portable terminal 6.

Incidentally, as another example of timing when the two-dimensional bar code is displayed, the time of actuation of the image forming apparatus 1 exists. That is, in the case where the image forming apparatus 1 is actuated, on the operating panel 2, for example, at the first, an initial screen such as a logo mark (logotype) of a manufacturer of the image forming apparatus 1 is displayed and thereafter the two-dimensional bar code may also be displayed with no operation by the user. In this case, the two-dimensional bar code may also be displayed even when the human sensor 15 detects the person or may also be displayed when the human sensor 15 detects the person. Further, on the initial screen immediately after the main switch of the image forming apparatus 1 is turned on, for example, the two-dimensional bar code may also be displayed together with the logo mark and may also be displayed alone.

In either case, in this embodiment, even when the user does not operate, the CPU 7 causes the operating panel 2 to display the two-dimensional bar code on the display portion 2a in a top menu in the stand-by state. Specifically, the CPU 7 causes the operating panel 2 to display a two-dimensional bar code (QR code: registered trademark) 1001 as shown in FIG. 16. In FIG. 16, in addition to the two-dimensional bar code 1001, information 1002 to the effect that the user is caused to read the two-dimensional bar code is also displayed. Incidentally, on a screen as shown in FIG. 16, in addition to the two-dimensional bar code 1001, buttons (software keys) for shifting to a screen (manual log-in screen) on which the user manually inputs information for authenticating the user by the image forming apparatus 1 may also be displayed.

In the top menu described as an example in this embodiment, for example, an operation menu such as “COPY”, “FAX” and “SCAN” may also be displayed at the same time. A constitution in which the two-dimensional bar code 1001 which is the reading image is displayed on that screen in response to the turning-on of the display portion 2a.

Next, the CPU 7 discriminates whether or not wireless LAN connection requirement based on the two-dimensional bar code by the user was made (S103). That is, the CPU 7 discriminates whether or not the requirement of the wireless LAN connection from the portable terminal 6 to the image forming apparatus 1 is made by reading the two-dimensional bar code 1001 with the camera 38 of the portable terminal 6 by the user. When the CPU 7 discriminates that the wireless LAN connection requirement to the image forming apparatus 1 was made (YES of S103), a wireless LAN connection process based on the two-dimensional bar code is performed (S104). The wireless LAN connection process based on the two-dimensional bar code will be described later.

Then, there is no problem about the pieces of information on the SSID, the PASSKEY and the IP address which are wireless LAN communication setting information acquired by reading of the two-dimensional bar code, the wireless LAN connection is completed, so that the CPU 7 ends a series of operations (S107).

On the other hand, in S103, when the CPU 7 discriminates that the wireless LAN connection requirement to the image forming apparatus 1 was not made (NO of S103), the CPU 7 discriminates whether or not NFC reading interruption occurred (S105). For example, the user operates the operating panel 2, and thus a target mark for NFC is displayed on the display portion 2a, and then user holds the portable terminal 6 over this target mark and thus discriminates whether or not the NFC is established. The target mark is a mark indicating a predetermined position over which the user holds the portable terminal 6 in order to carry out the NFC between the image forming apparatus 1 and the portable terminal 6. Incidentally, in the case where the target mark is provided at a position other than the display portion 2a, the user holds the to portable terminal 6 over that position and discriminates whether or not the NFC is carried out.

When the CPU 7 discriminates that interruption of the NFC reading to the image forming apparatus 1 was made (YES of S105), the CPU 7 performs a wireless LAN connection process based on the NFC (S106). The wireless LAN connection process based on the NFC will be described later. When there is no problem about the pieces of information on the SSID, the PASSKEY, and the IP address which are wireless LAN connection setting information acquired by the NFC, the wireless LAN connection is completed, so that the CPU 7 ends the series of operations (S107).

In S105, in the case where the CPU 7 discriminated that the NFC reading interruption to the image forming apparatus 1 was not made (NO of S105), the process is returned to S102. Incidentally, in this embodiment, the two-dimensional bar code 1001 is continuously displayed until the wireless LAN connection based on the two-dimensional bar code or the NFC is completed or the user manually shifts the screen to another screen (for example, a manual log-in screen). However, in the case where no operation is performed in the stand-by state and after a lapse of a predetermined time, the stand-by state shifts to the sleep mode, the screen on the display portion 2a disappears, so that the two-dimensional bar code is not displayed.

### [Wireless LAN Connection Based on NFC]

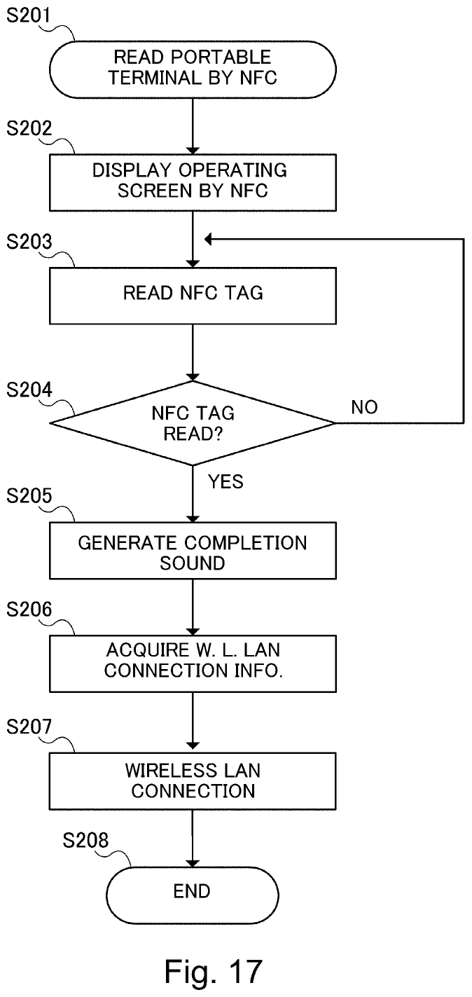

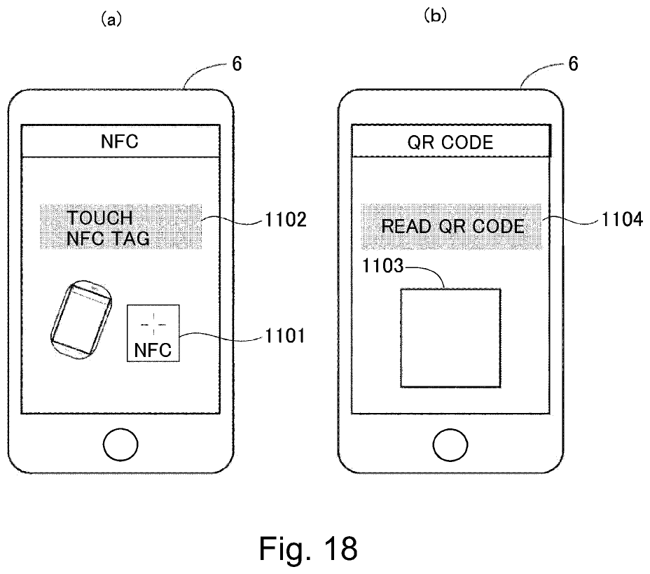

Next, the wireless LAN connection based on the NFC will be described by using FIG. 17. In the case where the user intends to establish the wireless LAN connection between the portable terminal 6 and the image forming apparatus 1 through the NFC, in order to perform the reading of the portable terminal 6 through the NFC, the user performs the operation for the NFC connection (S201). For example, in the case where the portable terminal 6 is a smartphone, the user launches an application for the NFC connection. Then, the CPU 32 (FIG. 10) of the portable terminal 6 causes the operating panel 32 to display, on the display portion 34a, for example, an operation screen through the NFC as shown in part (a) of FIG. 18 (S202).

In part (a) of FIG. 18, on the display portion 34a in order to establish the NFC, a target mark 1101 indicating an operator position over which the user holds the portable terminal 6 and an image indicating a state in which the portable terminal 6 is going to be held over the target mark 1101. Further, on the display portion 34a, a message 1102 to the effect that in instruction is provided so that the user brings the portable terminal 6 near to (touches) the target mark 1101 which is a position where the NFC tag is provided is also displayed. Incidentally, the user is not essentially required to perform the NFC connection of the portable terminal 6, but a constitution in which said display is not made may also be employed. For example, in the case where the user knows a place of the NFC tag (FIG. 7) of the image forming apparatus 1, even when such display is not made, the user is capable of carrying out the NFC.

Next, the user brings the portable terminal 6 near to (touches) the target mark of the image forming apparatus 1, whereby the CPU 32 of the portable terminal 6 reads the NFC tag portion 4 of the image forming apparatus 1 by the NFC R/W portion 36 (FIG. 10) (S203). As described above, the NFC R/W portion 36 carries out the NFC by electromagnetic coupling to the NFC tag portion 4 of the image forming apparatus 1, so that the CPU 32 reads the NFC tag data of the NFC tag portion 4.

Next, the CPU 32 of the portable terminal 6 discriminates whether or not the reading of the NFC tag data is completed (S204). That is, the CPU 32 discriminates whether or not the NFC based on the NFC standard between the NFC R/W portion 36 and the NFC tag portion 4 of the image forming apparatus 1 is completed. In the case where the CPU 32 discriminated that the NFC was completed (YES of S204), the CPU 32 causes the operation sound generating portion 34c (FIG. 10) to generate a completion sound indicating completion of the NFC (S205).

On the other hand, in S204, in the case where the CPU 32 discriminated that the NFC was not completed (NO of S204), the process returns to S203, and the NFC tag reading operation is repeated. Incidentally, in the case where the NFC is not completed even when the NFC tag (data) reading operation is repeated a predetermined number of times, the operation is stopped and then display to the effect that the NFC was not able to be established is displayed on the display portion 34a of the operating panel 2 of the portable terminal 6 may also be displayed.

Next, the CPU 32 of the portable terminal 6 acquires the NFC tag data read in S204, as the setting information necessary to establish the wireless LAN direct connection and communication (S206). As described above, it is assumed that in the memory 22 (FIG. 8) of the NFC tag portion 4 of the image forming apparatus 1, the pieces of information on the SSID, the PASSKEY and the IP address which are the setting information necessary to establish the wireless LAN direct connection and communication are written (stored) in advance as the NFC tag data. Accordingly, the CPU 32 acquires the pieces of information on the SSID, the PASSKEY and the IP address which are the setting information necessary to establish the wireless LAN direct connection and communication, by reading the NFC data.

Next, the CPU 32 of the portable terminal 6 carries out the wireless LAN connection with the image forming apparatus 1 (S207). By this, the CPU 32 ends the series of operations (S208).

### [Wireless LAN Connection Based on Two-Dimensional Bar Code]

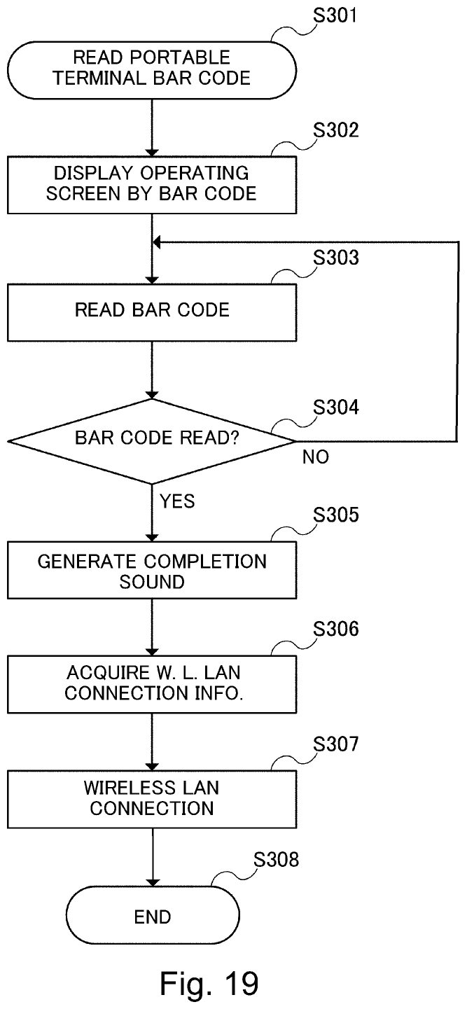

Next, the wireless LAN connection based on the two-dimensional bar code will be described by using FIG. 19. In the case where the user intends to establish the wireless LAN connection between the portable terminal 6 and the image forming apparatus 1 by reading the two-dimensional bar code, the user performs the operation for reading the two-dimensional bar code (S301). For example, in the case where the portable terminal 6 is a smartphone, the user launches an application for reading the two-dimensional bar code. Then, the CPU 32 (FIG. 10) of the portable terminal 6 causes the operating panel 32 to display, on the display portion 34a, for example, an operation screen through the two-dimensional bar code (QR code: registered trademark) as shown in part (b) of FIG. 18 (S302).

In part (a) of FIG. 19, on the display portion 34a, an image pick-up area 1103 for taking (pick up) a two-dimensional bar code image when the user reads the two-dimensional bar code with the camera 38 of the portable terminal 6 is displayed. Further, on the display portion 34a, a message 1104 providing an instruction so that the user reads, with the portable terminal 6, the two-dimensional bar code displayed on the image forming apparatus 1 is also displayed.

Next, the user reads the two-dimensional bar code 1001 (FIG. 16) displayed on the display portion 2a of the image forming apparatus 1 with the camera 38 (S303). That is, the user causes the two-dimensional bar code 1001 to fall within the image pick-up area 1103 by the camera 38, and thus detects and takes this two-dimensional bar code. Thereafter, the CPU 32 analyzes the taken two-dimensional bar code by the two-dimensional bar code analyzing portion 39 (FIG. 10), and thus acquires two-dimensional bar code data.

Next, the CPU 32 of the portable terminal 6 discriminates whether or not the reading of the two-dimensional bar code is completed and the data is to acquired (S304). In the case where the CPU 32 discriminated that the two-dimensional bar code data was acquired (YES of S304), the CPU 32 causes the operation sound generating portion 34c (FIG. 10) to generate a completion sound indicating completion of reading of the two-dimensional bar code (S305).

On the other hand, in S304, in the case where the CPU 32 discriminated that the two-dimensional bar code data was not acquired (NO of S304), the process returns to S303, and the two-dimensional bar code reading operation is repeated. Incidentally, in the case where the reading of the two-dimensional bar code is not completed even when the two-dimensional bar code reading operation is repeated a predetermined number of times, the operation is stopped and then display to the effect that the two-dimensional bar code reading was not able to be performed is displayed on the display portion 34a of the operating panel 2 of the portable terminal 6 may also be displayed.

Next, the CPU 32 of the portable terminal 6 acquires the two-dimensional bar code data read in S303, as the setting information necessary to establish the wireless LAN direct connection and communication (S306). The CPU 32 acquires the pieces of information on the SSID, the PASSKEY and the IP address which are the setting information necessary to establish the wireless LAN direct connection and communication, by reading the two-dimensional bar code.

Next, the CPU 32 of the portable terminal 6 carries out the wireless LAN connection with the image forming apparatus 1 (S307). By this, the CPU 32 ends the series of operations (S308).

As described above, in the case of this embodiment, in a top menu on the image forming apparatus 1, the two-dimensional bar code as the reading image is displayed with no operation by the user. For this reason, operativity of the operator in the case where permission of the wireless LAN communication and authentication of the operator are carried out by using the two-dimensional bar code. In other words, the user is not required to perform a plurality of operations in the order of, for example, “MOBILE” to “AR DISPLAY” from the top menu screen. As a result, in the case where the operator wishes to connect the portable terminal 6 to the image forming apparatus 1 by the reading of the two-dimensional bar code, time and trouble of the operation for displaying the two-dimensional bar code can be omitted.

Incidentally, in the above-described explanation, the NFC tag data and the two-dimensional bar code data were used as the setting information for carrying out the wireless LAN direct communication, and were handed over to the wireless LAN direct communication. However, in this embodiment, a constitution in which the NFC tag data and the two-dimensional bar code data are replaced with other pieces of information and then are transmitted may also be employed. For example, the NFC tag data and the two-dimensional bar code data are replaced with the setting information (for example, ID and PASSWORD) for carrying out the individual (personal) authentication as described above, and then only the individual authentication may also be carried out by using this setting information.

Further, the timing when the two-dimensional bar code is displayed is not limited to the time when the human sensor 15 detected the person in the sleep mode. For example, the two-dimensional bar code may also be displayed also in the case where in the stand-by state, after a lapse of a time to the extent that the stand-by state shifts to the sleep mode from after the human sensor 15 does not detect the person once, the human sensor 15 detects the person again. As an example of such a case, the case where a previous operator authenticated and permitted to use the image forming apparatus 1 goes away from the front of the image forming apparatus 1 and then another person comes to the front of the image forming apparatus 1 in a state in which the image forming apparatus 1 is kept in the stand-by state would be considered.

### Second Embodiment

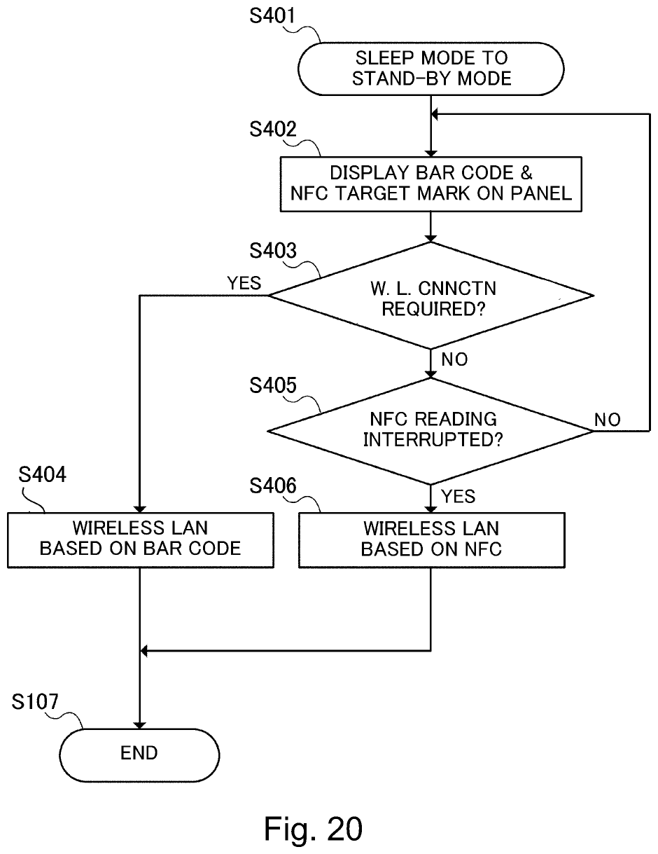

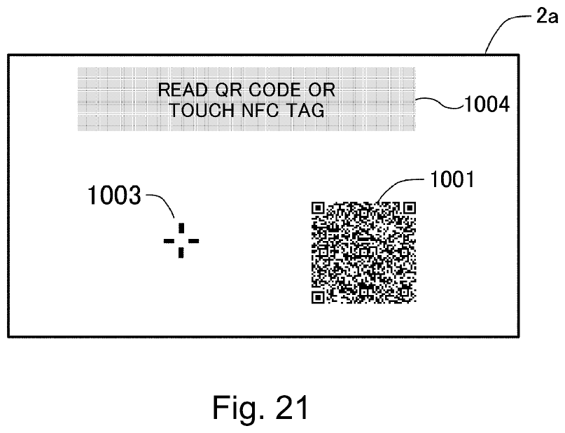

A second embodiment will be described by using FIGS. 20 and 21 while making reference to FIGS. 1 to 14, 17 and 19. In the above-described first embodiment, the two-dimensional bar code and the target mark for the NFC were displayed on different screens on the display portion 2a of the operating panel 2 of the image forming apparatus 1. On the other hand, in this embodiment, the two-dimensional bar code and the target mark for the NFC are displayed simultaneously on the display portion 2a. Other constitution and actions are similar to those in the first embodiment, and therefore, the same constituent elements are described by using the same reference numerals or symbols and will be omitted from illustration and description.

An operation sequence of the CPU 7 of the image forming apparatus 1 of this embodiment will be described by using FIG. 20. FIG. 20 is a flowchart substantially identical to the flowchart shown in FIG. 15 in the first embodiment. That is, the flowchart of FIG. 20 is the same as the flowchart of FIG. 15 except for S402. In FIG. 15, when the human sensor 15 detects the person and the state of the image forming apparatus 1 is restored from the sleep mode to the stand-by state, the CPU 7 caused the display portion 2a to display the two-dimensional bar code on the screen of the display portion 2a. On the other hand, in FIG. 20, on the display portion 2a, the two-dimensional bar code and the target mark for the NFC are displayed at the same time.

Specifically, in S401, when the state of the image forming apparatus 1 is restored from the sleep mode to the stand-by state, the CPU 7 causes the screen of the display portion 2a to display the target mark for the NFC simultaneously with the two-dimensional bar code as the reading image (S402). The target mark for the NFC is the image indicating the position over which the portable terminal 6 is held for carrying out the near-field wireless communication (NFC) between the portable terminal 6 and the image forming apparatus 1.

Incidentally, as another example of the timing when the two-dimensional bar code and the target mark are displayed, there is a time when the image forming apparatus 1 is actuated. That is, in the case where the image forming apparatus 1 is actuated by turning on the main switch of the image forming apparatus 1, after the initial screen such as the logo mark is displayed on the operating panel 2, the two-dimensional bar code and the target mark may also be displayed with no operation by the user. In this case, the two-dimensional bar code and the target mark may also be displayed even when the human sensor 15 does not detect the person or when the human sensor 15 detects the person. Further, on the initial screen immediately after the main switch of the image forming apparatus 1 is turned on, for example, the two-dimensional bar code and the target mark may also be displayed together with the logo mark, or only the two-dimensional bar code and the target mark may also be displayed.

In either case, even when the user does not operate the operating panel 2, the CPU 7 of the image forming apparatus 1 causes the display portion 2a to display, in the top menu in the stand-by state, the two-dimensional bar code 1001 and the target mark 1003 for the NFC at the same time as shown in FIG. 21. In FIG. 21, in addition to the two-dimensional bar code 1001 and the target mark 1003, information 1004 to the effect that the user is prompted to read the two-dimensional bar code or to perform an NFC touch operation is also displayed.

Incidentally, in the screen as shown in FIG. 21, a button (software key) for manually shifting to a screen (manual log-in screen) through which information for authenticating the user by the image forming apparatus 1 is inputted may also be displayed. Processes of S403 and later are the same as the processes of S103 and later.

Also, in the case of this embodiment described above, operativity of the operator in the case where the permission of the wireless LAN communication and the authentication of the operator are carried out by using the two-dimensional bar code can be improved. Further, on the image forming apparatus 1, in the top menu, the target mark for the NFC is displayed with no operation by the user, and therefore, a time and a trouble to seek the target mark can be reduced. Further, the two-dimensional bar code and the target mark for the NFC are displayed at the same time, and therefore, the user readily selects either one thereof.

### Third Embodiment

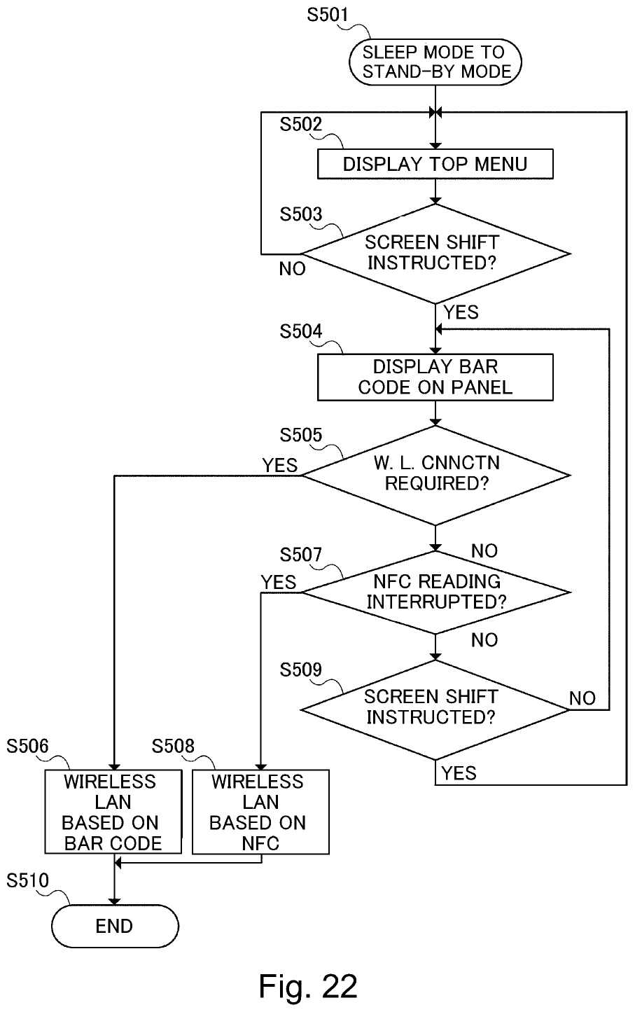

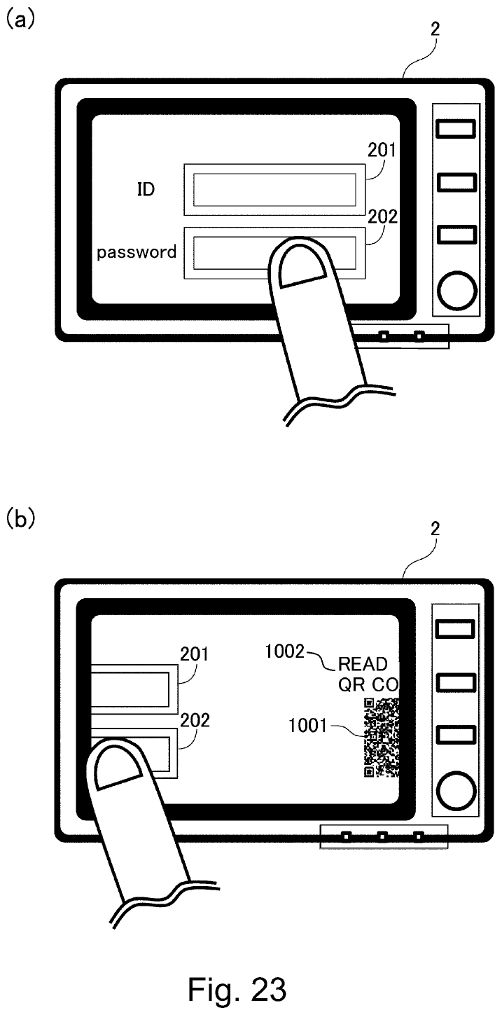

A third embodiment will be described by using FIG. 22 and parts (a) and (b) of FIG. 23 while making reference to FIGS. 1 to 14, 17 and 19. In the above-described first embodiment, the two-dimensional bar code was displayed when the state of the image forming apparatus 1 is restored from the sleep mode to the stand-by state. On the other hand, in this embodiment, the two-dimensional bar code as a screen for authentication is displayed by performing a single operation such as a swipe operation by the operator (hereinafter referred to as the user) on the initial screen when restored to the initial screen. Other constitution and actions are similar to those in the first embodiment, and therefore, the same constituent elements are described by using the same reference numerals or symbols and will be omitted from illustration and description.

First, in this embodiment, on the operating panel 2, in addition to the touch operation, the swipe operation can be performed. Further, an operation such as a flick may also be enabled. Here, an operation in which the user contacts the operating panel 2 with his (her) finger is defined as “touch (operation)”, an operation in which the user moves his (her) finger on the operating panel 2 without separating his (her) finger from the operating panel 2 after the user performs the toner operation is defined as a “drag operation”, and an operation in which the user releases his (her) finger from the operating panel 2 after the user performs the toner operation is defined as a “release (operation)”. Further, an operation in which after the toner operation, the user continues the drag operation at a certain speed and then performs the release operation is defined as a “swipe (operation)”, and an operation in which the user performs the drag operation for a time shorter than the certain time in the “swipe” operation, i.e., after the touch operation, the user moves his (her) finger quickly so as to flick the operating panel 2 is defined as a “flock (operation)”. The “swipe” operation is also characterized in that compared with the “flock” operation, a range in which the user moves his (her) finger in a state in which the user contacts the operating panel 2 with his (her) finger is broad. Incidentally, an operation in which the user scrolls the screen with his (her) finger is included in the “swipe” operation.

An operation sequence of the CPU 7 of the image forming apparatus 1 of this embodiment will be described by using FIG. 22.

First, it is assumed that the image forming apparatus 1 is in the sleep mode (state). Further, for example, when the human sensor 15 detects the person, the state of the image forming apparatus 1 is restored from the sleep mode to the stand-by state (S501). Then, the CPU 7 causes the operating panel 2 to display the top menu (initial screen) on a screen of the display portion 2a (S502).

In S502, the CPU 7 causes the display portion 2a to display, as the top menu in the stand-by state, for example, the manual log-in screen on which a user ID, a password and the like are manually inputted. Incidentally, the top menu may also be a screen on which operation icons (software keys) such as “COPY” and “SCAN” are displayed. On this screen, when the user touches the button such as “COPY”, the image forming apparatus 1 performs a designated operation.

Next, the CPU 7 of the image forming apparatus 1 discriminates whether or not a screen shift instruction by the swipe operation was provided (S503). In this regard, description will be made by using parts (a) and (b) of FIG. 23. First, part (a) of FIG. 23 is an example of the manual log-in screen (authentication screen) displayed on the display portion 2a of the operating panel 2 when the state of the image forming apparatus 1 is restored from the sleep mode to the stand-by state. On the manual log-in screen of part (a) of FIG. 23, a manual input box 201 for the ID and a manual input box 202 for the password which are necessary to log in to the image forming apparatus 1 are displayed. The user touches each of the manual input boxes and selects an input destination, and inputs information by the keys 20b (FIG. 2), so that manual log-in is carried out. Incidentally, in the case where the user touches the manual input box, on the operating panel 2, software keys by which characters such as alphabet and numerals are capable of being inputted may also be displayed. In this case, the user inputs the information to each of the boxes by the touch operation and thus logs in to the image forming apparatus 1 manually.

The user not only logs in the image forming apparatus 1 manually on the screen of part (a) of FIG. 23 but also is capable of displaying a screen of part (b) of FIG. 23 by swiping the screen of part (a) of FIG. 23. That is, from the state of part (a) of FIG. 23, when the user swipes the screen from the right side toward the left side with his (her) finger, as shown in part (b) of FIG. 23, the screen for permitting reading of the two-dimensional bar code 1001 appears. That is, the CPU 7 causes the display portion 2a to display the two-dimensional bar code 1001 only by a single swipe of the manual log-in screen by the user.

Incidentally, as another example of the timing of displaying the initial screen, the time of actuating the image forming apparatus 1 exists. That is, in the case where the image forming apparatus 1 is actuated by turning on the main switch thereof, the initial screen is displayed on the operating panel 2. The initial screen at this time may also be the logo mark or the like. Then, the two-dimensional bar code is displayed by swiping once the screen on which the logo mark is displayed.

In S503, when the CPU 7 discriminated that the screen shift instruction by the swipe is provided to the operating panel 2 (YES of S503), as shown in part (b) of FIG. 23, the two-dimensional bar code 1001 is displayed on the screen of the operating panel 2 (S504). Incidentally, on this screen, information 1002 to the effect that the user is caused to read the two-dimensional bar code is also displayed. Further, in this embodiment, by swinging this screen in an opposite direction, the screen is returned to the manual log-in screen. However, on this screen, buttons (software keys) for returning to a screen (manual log-in screen) on which the user manually inputs information for authenticating the user by the image forming apparatus 1 may also be displayed. In S503, in the case where the CPU 7 discriminated that the screen shift instruction by the swipe operation was not provided (NO of S503), the process returns to S502.

Next, the CPU 7 discriminates whether or not wireless LAN connection requirement based on the two-dimensional bar code by the user was made (S505). S505 is the same as S103 of FIG. 15. When the CPU 7 discriminated that the wireless LAN connection requirement to the image forming apparatus 1 was made (YES of S505), a wireless LAN connection process based on the two-dimensional bar code is performed (S506).

Then, there is no problem about the pieces of information on the SSID, the PASSKEY and the IP address which are wireless LAN communication setting information acquired by reading of the two-dimensional bar code, the wireless LAN connection is completed, so that the CPU 7 ends a series of operations (S510).

On the other hand, in S505, when the CPU 7 discriminates that the wireless LAN connection requirement to the image forming apparatus 1 was not made (NO of S505), the CPU 7 discriminates whether or not NFC reading interruption occurred (S507). S507 is the same as S105 of FIG. 15.

When the CPU 7 discriminates that interruption of the NFC reading to the image forming apparatus 1 was made (YES of S507), the CPU 7 performs a wireless LAN connection process based on the NFC 508). When there is no problem about the pieces of information on the SSID, the PASSKEY, and the IP address which are wireless LAN connection setting information acquired by the NFC, the wireless LAN connection is completed, so that the CPU 7 ends the series of operations (S510).

In S507, in the case where the CPU 7 discriminated that the NFC reading interruption to the image forming apparatus 1 was not made (NO of S507), the CPU 7 discriminates or not the screen shift instruction by the swipe operation was provided (S509). When the CPU 7 discriminates that the screen shift instruction was provided (YES of S509), the process is returned to S502, and the top menu is displayed on the operating panel 2.

On the other hand, in S509, when the CPU 7 discriminates that the screen shift instruction by the swipe operation was not provided (NO of S509), the process is returned to S504. Incidentally, in this embodiment, the two-dimensional bar code 1001 is continuously displayed until the wireless LAN connection based on the two-dimensional bar code or the NFC is completed or the screen is returned to the manual log-in screen. However, in the case where no operation is performed in the stand-by state and after a lapse of a predetermined time, the stand-by state shifts to the sleep mode, the screen on the display portion 2a disappears, so that the two-dimensional bar code is not displayed.

As described above, in this embodiment, the two-dimensional bar code is displayed only by performing a single operation (the swipe operation in this embodiment) by the user in the top menu or the image forming apparatus 1. For this reason, it is possible to reduce a time and a trouble of the user who intends to use the two-dimensional bar code.

That is, in this embodiment, on the manual log-in screen displayed in response to restoration from the sleep mode to the stand-by state, the user is capable of switching the manual log-in screen to the screen on which the two-dimensional bar code is displayed, only by performing a single swipe operation. For this reason, in the case where permission of the wireless LAN communication or user authentication is carried out by reading the two-dimensional bar code with the portable terminal 6, the user is not required to touch the screen repeatedly from the manual log-in screen, and is capable of causing the display portion 2a to display the two-dimensional bar code only by swiping the screen once.

Incidentally, in the above, the two-dimensional bar code was displayed by performing the swipe operation once on the initial screen displayed when the state of the image forming apparatus is restored from the sleep mode to the stand-by state. However, the two-dimensional bar code may also be displayed by performing an operation such as the touch operation or the flick operation once on the initial screen. That is, in order to display the two-dimensional bar code, the single operation performed by the operator is not limited to the swipe operation, but may also be the operation such as the touch operation or the flick operation. In the case where the touch operation or the flick operation is performed, a button to the effect that the two-dimensional bar code is displayed is displayed on the initial screen, and then the operator may also touch or flick this button. Further, in the case where the swipe operation is performed, on the initial screen, a message to the effect that the two-dimensional bar code is displayed by the swipe operation, and in addition, a swiping direction may also be displayed.

Further, in this embodiment, the two-dimensional bar code was displayed by performing the single operation on the initial screen, but similarly as in the second embodiment, the two-dimensional bar code and the target mark for the NFC may also be displayed at the same time.

### Another Embodiment

In the above-described embodiments, the constitution in which the loop antenna 26 of the NFC tag portion 5 for carrying out the NFC with the portable terminal 6 was disposed in the operating panel 2 was described. However, the loop antenna 26 may also be disposed outside the operating panel 2. For example, the loop antenna 26 may also be disposed at a position adjacent to the operating panel 2. In this case, on a screen showing a message to the effect that the portable terminal 6 is held over a predetermined position of the image forming apparatus 1, a position where the loop antenna 26 is disposed is displayed as the predetermined position over when the portable terminal 6 is held.

Further, in the above-described embodiments, when the human sensor 15 detects the person, the state of the image forming apparatus 1 is shifted from the sleep mode to the stand-by state, but the human sensor 15 may also be omitted. In this case, for example, a button capable of releasing the sleep mode is provided on the operating panel 2, and the sleep mode may also be released by operating this button. Or, the sleep mode may also be released by operating either one of the software keys 20b. Or, the sleep mode may also be released by touching the operation display portion 20a.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-211776 filed on Nov. 22, 2019, which is hereby incorporated by reference herein in its entirety.

What is claimed is:

1. An image forming apparatus comprising:
an image forming portion capable of forming an image on a sheet on the basis of image data sent from a portable terminal and received through wireless communication;
a display panel configured to display a reading image which includes information for permitting wireless communication with said image forming apparatus and which is readable by a camera of the portable terminal; and
a controller capable of executing an operation in a first mode in which said display panel is turned on in a state that said image forming apparatus waits for the near field wireless communication with the portable terminal and an operation in a second mode in which electric power consumption is smaller than electric power consumption in said first mode and in which said display panel is turned off,
wherein said controller causes said display panel to display said reading image in response to restoration from said second mode to said first mode.

2. An image forming apparatus according to claim 1, further comprising a power supply capable of supplying electric power to portions of said image forming apparatus,
wherein in said first mode, the electric power is supplied from said power supply to said display portion, and
in said second mode, the electric power is not supplied from said power supply to said display portion.

3. An image forming apparatus according to claim 1, further comprising a human sensor capable of detecting presence of a person in a predetermined region on a periphery of said image forming apparatus,
wherein said controller restores an operation mode of said image forming apparatus from said second mode to said first mode in a case that said human sensor detects the presence of said person in said second mode.

4. An image forming apparatus according to claim 1, further comprising:
a communication portion configured to communicate with a portable terminal through near field wireless communication slower in communication speed than the wireless communication;
a permitting portion configured to permit the wireless communication with the portable terminal on the basis of the near field wireless communication by said communication portion.

5. An image forming apparatus according to claim 4, wherein said display portion displays, together with said reading image, an image indicating a position where the portable terminal is held over said display portion so as to carry out near field wireless communication with the portable terminal.

6. An image forming apparatus according to claim 4, further comprising an operating panel including said display portion through which an operator is capable of inputting information by a touch operation and including an antenna configured to carry out the near field wireless communication with the portable terminal.

7. An image forming apparatus comprising:
an image forming portion capable of forming an image on a sheet on the basis of image data sent from a portable terminal and received through wireless communication;
an operating panel including a display panel configured to display a reading image which includes information for permitting wireless communication with said image forming apparatus and which is readable by a camera of the portable terminal, and including an operating portion through which an operator is capable of inputting information by a touch operation;
a controller capable of executing an operation in a first mode in which said display panel is turned on in a state that said image forming apparatus waits for the near field wireless communication with the portable terminal and an operation in a second mode in which electric power consumption is smaller than electric power consumption in said first mode and in which said display panel is turned off,
wherein said controller causes said display panel to display said reading image by a single operation performed by the operator on an initial screen of said display portion when an operation mode of said image forming apparatus is restored from said second mode to said first mode.

8. An image forming apparatus according to claim 7, wherein said single operation is a swipe operation.
